(19) United States
(12) Patent Application Publication
(10) Pub. No.: US 2008/0075063 A1
(43) Pub. Date: Mar. 27, 2008

(54) INTEGRATED SYSTEM AND METHOD ROUTING OPTIMIZED COMMUNICATION PATH OF MULTIMEDIA DATA UNDER USER'S CONFIGURATION OF COMMUNICATION

(76) Inventor: Kyung-Lim Ha, Gwangju (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/859,628

(22) Filed: Sep. 21, 2007

Related U.S. Application Data
(63) Continuation of application No. PCT/KR06/01056, filed on Mar. 23, 2006.

(30) Foreign Application Priority Data
Mar. 23, 2005 (KR) 10-2005-0024215

(51) Int. Cl. H04L 12/28

(52) U.S. Cl. 370/351

(57) ABSTRACT

A multimedia integrated communication system for analyzing a fittest communication routing is disclosed. In one embodiment, the system includes i) communication means for transmitting and receiving multimedia communication data of the users, ii) a multimedia routing platform for transmitting and receiving the multimedia communication data to/from the communication means, and controlling the communication means so that the voice and image signals are communicated through a fittest communication routing by integrating/converging different kinds of communication means, iii) a network including a wire/wireless telephone network and a wire/wireless data communication network for transmitting and receiving the multimedia communication data and iv) an agency server for grasping communication environment information of the communication means through the platform, and determining a fittest multimedia communication routing before a call is connected and then transmitting the multimedia communication data therethrough.

### RELATED APPLICATIONS

This application is a continuation application, and claims the benefit under 35 U.S.C. §§ 120 and 365 of PCT Application No. PCT/KR2006/001056, filed on Mar. 23, 2006 and, which is hereby incorporated by reference.

### BACKGROUND OF THE INVENTION

1. Field of the Invention

The present invention relates to a multimedia integrated communication system and method, and more particularly to a multimedia integrated communication system and method for connecting a call by a fittest routing analyzed in consideration of all communication environments of an originator and a recipient in response to a multimedia call request of a user. This invention also relates to providing a fittest communication routing according to multimedia communication environments of a user, which provides a fittest multimedia communication service, in a way that, if an originator transmits voice and image using a voice communication means and an image communication means respectively, a recipient side synchronizes them.

2. Description of the Related Technology

In the current communication market, all networks are developed toward next generation network (NGN) or broadband convergence network (BcN) that allow communication with all Internet protocol (IP) devices, and the convergence for converging communication and broadcast is progressed.

As for communication terminals, there appear third generation (3G) cellular phones, digital multimedia broadcasting (DMB) phones, wireless local area network (WLAN) phones, IP videophone and so on in order to support various kinds of multimedia.

### SUMMARY OF CERTAIN INVENTIVE ASPECTS

One aspect of the present invention provides a system and method capable of utilizing a PC as a videophone display for image communication in a company and also capable of making a call using an extension phone.

Another aspect of the present invention provides a method and system capable of giving a fittest communication if different kinds of communication devices (e.g., PC and an extension phone) are spatially connected (using the same platform).

Another aspect of the present invention is directed to calculating a fittest communication routing integrally connected by different kinds of plural or single communication means by analysis of communication environments of an originator and a recipient in response to a call request of a user, and then providing a multimedia communication service of voice and image through the fittest multimedia communication routing.

Another aspect of the present invention provides a multimedia integrated communication system for routing a fittest communication routing of multimedia data under user's configuration of communication, wherein the multimedia integrated communication system for providing a multimedia calling service classified into voice and image signals between users includes i) at least one communication means for transmitting and receiving multimedia communication data of the users, ii) a multimedia routing platform for transmitting and receiving the multimedia communication data to/from the communication means, and controlling the communication means so that the voice and image signals are communicated through a fittest communication routing by integrating/converging different kinds of communication means, iii) a network including a wire/wireless telephone network and a wire/wireless data communication network for transmitting and receiving the multimedia communication data and iv) an agency server for grasping communication environment information of the communication means through the platform, and determining a fittest multimedia communication routing before a call is connected and then transmitting the multimedia communication data therethrough.

According to one embodiment of the present invention, as for the fittest multimedia communication routing, a fittest voice communication routing and a fittest image communication routing are respectively set based on priority information including charge, quality and security items set in the agency server by the user.

In addition, the fittest multimedia communication routing may be a fittest multimedia communication routing determined by replacing a voice communication means, with which an originating side (or, a sending side) initially requests a call, with a fittest communication means by the agency server in consideration of the communication means of an originator and a recipient.

Another aspect of the present invention provides a multimedia communication method for providing multimedia call service between users, wherein the multimedia communication method for providing multimedia communication service between users includes i) a multimedia agency server storing personal information of a user who intends to join as a member, and providing and installing software and hardware multimedia routing platforms as a multimedia communication means, ii) automatically or manually registering multimedia communication environment information including voice communication means, image communication means and presence information from the communication means; iii) receiving a call request of an originator through the multimedia routing platform from the communication means; iv) receiving a fittest multimedia communication routing request including phone numbers of an originator and a recipient from the multimedia routing platform of an originating side; v) analyzing a fittest voice communication routing and a fittest image communication routing based on priority information including charge, quality and security items set by the user by grasping the multimedia communication environment information; vi) in case of a voice signal, connecting a voice call by controlling a platform corresponding to the fittest voice communication routing; vii) in case of an image signal, transmitting image information by controlling a platform corresponding to the fittest image communication routing; and viii) the image communication means of the originator and the recipient regenerating image information when the recipient hooks off the voice communication means in the step.

Another aspect of the invention provides a method of providing an optimal telecommunication route, the method comprising: a) communicating data with an originating terminal and a receiving terminal, wherein at least one of the originating terminal and receiving terminal is configured to support multimedia data communication, b) storing i) priority information provided by a user of the originating terminal and ii) information associated with telecommunication routes between the originating terminal and receiving terminal, wherein the priority information comprises a plurality of telecommunication connection criteria and their relative rankings defined by the user, and wherein the communication route information comprises a list of a plurality of telecommunication networks which indicates the relative rankings of the plurality of telecommunication networks for each of the plurality of telecommunication connection criteria, c) receiving a request for telecommunication route information from the originating terminal, d) obtaining an optimal telecommunication route, based on the stored information i) and ii), between the originating terminal and receiving terminal and e) transmitting the obtained optimal route to the originating terminal.

The optimal telecommunication route may be the telecommunication network which has the highest ranking on the telecommunication connection criterion selected by the user to be the highest priority. The telecommunication connection criteria may comprise communication quality, service fees and communication security. The method may further comprise detecting the type of the originating terminal, wherein the optimal telecommunication route is obtained based on the stored information and the detected terminal type. The method may further comprise storing iii) relationship information between the user and a plurality of recipients, wherein the optimal telecommunication route is obtained based on the stored information (i)-iii)). The relationship information may define the degree of the relationship, and the rank of a recipient may become higher as the user becomes closer in relationship to the recipient.

The method may further comprise downloading a software platform to the originating terminal, wherein the optimal route information is configured to control the software platform of the originating terminal to communicate data with the recipient terminal. The optimal route information may comprise a first route for voice communication and a second route for video communication, wherein the first and second routes are different from each other. The optimal route information may be configured to control the originating terminal to separately communicate a voice signal via the first route and video data via the second route with the recipient terminal. The recipient terminal may comprise i) a computing device configured to process the video data and ii) an information terminal configured to process the voice signal. The information terminal may comprise a wired or wireless phone.

The obtained route information may comprise one of i) a forward communication route configured to connect a call for a voice signal from the originating terminal to the recipient terminal and ii) a backward communication route configured to connect a call for a voice signal from the recipient terminal to the originating terminal. The method may further comprise providing a peer-to-peer communication for multimedia data between the originating terminal and recipient terminal if both of the terminals support multimedia data communication. The method may further comprise transmitting multimedia data to the recipient terminal via a push protocol. The method may further comprise receiving a recipient's presence information, indicating the availability of the recipient, from the recipient terminal, wherein the timing for transmitting the multimedia data is controlled based on the presence information. The method may further comprise controlling the originating terminal so as to delay the connection between the originating and recipient terminals until the optimal telecommunication route information is transmitted to the originating terminal.

Another aspect of the invention provides a system for providing an optimal telecommunication route, the system comprising: a) a memory configured to store i) priority information provided by a user of an originating terminal and ii) information associated with telecommunication routes between the originating terminal and a receiving terminal, wherein the priority information comprises a plurality of telecommunication connection criteria and their relative rankings defined by the user, and wherein the communication route information comprises a list of a plurality of telecommunication networks which indicates the relative rankings of the plurality of telecommunication networks for each of the plurality of telecommunication connection criteria; and b) a processor configured to: i) communicate data with the originating terminal and receiving terminal, wherein at least one of the originating terminal and receiving terminal is configured to support multimedia data communication, ii) receive a request for telecommunication route information from the originating terminal, iii) obtain an optimal telecommunication route, based on the information stored in the memory, between the originating terminal and receiving terminal and iv) transmit the obtained route information to the originating terminal.

The optimal telecommunication route may be the telecommunication network which has the highest ranking on the telecommunication connection criterion selected by the user to be the highest priority. The telecommunication connection criteria may comprise communication quality, service fees and communication security. The optimal route information may comprise a first route for voice communication and a second route for video communication, wherein the first and second routes are different from each other. The memory may be further configured to store iii) relationship information between the user and a plurality of recipients, wherein the processor is further configured to obtain the optimal telecommunication route based on the stored information (i)-iii)). The plurality of telecommunication networks may comprise at least two of the following: a PSTN, a wired Internet, a wireless Internet and a wireless LAN.

Another aspect of the invention provides one or more processor-readable storage devices having processor-readable code, the processor-readable code for programming one or more processors to perform a method of providing an optimal telecommunication route, the method comprising: a) communicating data with an originating terminal and a receiving terminal, wherein at least one of the originating terminal and receiving terminal is configured to support multimedia data communication, b) storing i) priority information provided by a user of the originating terminal and ii) information associated with telecommunication routes between the originating terminal and receiving terminal, wherein the priority information comprises a plurality of telecommunication connection criteria and their relative rankings defined by the user, and wherein the communication route information comprises a list of a plurality of telecommunication networks which indicates the relative rankings of the plurality of telecommunication networks for each of the plurality of telecommunication connection criteria, c) receiving a request for telecommunication route information from the originating terminal, d) obtaining an optimal telecommunication route, based on the stored information i) and ii), between the originating terminal and receiving terminal and e) transmitting the obtained optimal route to the originating terminal.

Still another aspect of the invention provides a system for providing an optimal telecommunication route, the system comprising: a) means for communicating data with an originating terminal and a receiving terminal, wherein at least one of the originating terminal and receiving terminal is configured to support multimedia data communication, b) means for storing i) priority information provided by a user of the originating terminal and ii) information associated with telecommunication routes between the originating terminal and receiving terminal, wherein the priority information comprises a plurality of telecommunication connection criteria and their relative rankings defined by the user, and wherein the communication route information comprises a list of a plurality of telecommunication networks which indicates the relative rankings of the plurality of telecommunication networks for each of the plurality of telecommunication connection criteria, c) means for receiving a request for telecommunication route information from the originating terminal, d) means for obtaining an optimal telecommunication route, based on the stored information i) and ii), between the originating terminal and receiving terminal and e) means for transmitting the obtained optimal route to the originating terminal.

Yet another aspect of the invention provides a method of providing an optimal telecommunication route, the method comprising: a) providing to a server, at an originating terminal, priority information provided by a user of the originating terminal, wherein the priority information comprises a plurality of telecommunication connection criteria and their relative rankings defined by the user, and wherein the server is in signal or data communication with the originating terminal, b) transmitting a request for an optimal telecommunication route, between the originating terminal and a recipient terminal, to the server, wherein at least one of the originating terminal and receiving terminal is configured to support multimedia data communication, c) receiving an optimal telecommunication route from the server and d) communicating signal or data with the recipient terminal via the optimal telecommunication route.

### BRIEF DESCRIPTION OF DRAWINGS

Embodiments of the present invention will be described by referring to the accompanying drawings.

FIG. 1 shows a configuration of a multimedia integrated communication system according to a first embodiment of the present invention.

FIG. 2 is a concept view showing a communication environment in which voice and image are separated according to one embodiment of the present invention.

FIG. 3 shows a schematic configuration of a multimedia communication means and a platform environment according to one embodiment of the present invention.

FIG. 4 shows a configuration of an entire network according to the first embodiment of the present invention.

FIG. 5 shows an inner configuration of an agency server according to one embodiment of the present invention.

FIG. 6 shows an example of data of a communication environment information DB according to one embodiment of the present invention.

FIG. 7 shows an inner configuration of a H/W platform according to one embodiment of the present invention.

FIG. 8 shows process functions of the H/W platform according to one embodiment of the present invention.

FIG. 9 shows process functions of a S/W platform according to one embodiment of the present invention.

FIG. 10 shows communication environment information registration process functions in linkage of the H/W platform and a sensor according to the first embodiment of the present invention.

FIG. 11 shows communication environment information registration process functions in linkage of the S/W platform and the sensor according to the first embodiment of the present invention.

FIG. 12 shows a configuration of a multimedia integrated communication system according to a second embodiment of the present invention.

FIG. 13 is a flowchart illustrating the entire multimedia communication method according to the first embodiment of the present invention.

FIG. 14 is a detailed flowchart illustrating a multimedia fittest routing analyzing step according to one embodiment of the present invention.

FIGS. 15 to 18 are detailed flowcharts illustrating a voice communication process along the fittest voice communication routing according to one embodiment of the present invention.

FIGS. 19 and 20 are detailed flowcharts illustrating an image communication process along a fittest image communication routing according to one embodiment of the present invention.

FIGS. 21 and 22 are flowcharts illustrating the entire multimedia communication method according to the second embodiment of the present invention.

### DETAILED DESCRIPTION OF CERTAIN INVENTIVE EMBODIMENTS

Typically, a third party service provider may easily provide a communication service by using a soft switch and application programming interface (API), so the current communication market is more complicated, and a user may require various endeavors (such as subscription to an optimized charge system) in order to use his/her own most suitable communication service. However, it is substantially impossible to use a cheap and high-quality communication if communication environments of originator and recipient are all known.

An applicant of this invention has already suggested an integrated communication system and method for connecting a call between an originator and a recipient through a fittest communication routing according to a weight predetermined by an agency server if a CIS server is requested to calculate a fittest communication routing between the originator and the recipient, as disclosed in Korean Patent No. 0456123, entitled “Integrated communication system for routing a fittest communication routing according to communication terminal information of a user, and a communication method using the same,” which is incorporated herein by reference. In the above patent, service may be available only in a restricted environment, namely when communication means are all of the same kind, namely wire/wireless phones, and all communication means are physically connected. In addition, the communication data may also be limited to voice phone communication data.

In addition, in the above patent, a fittest routing service can be provided only when communication data is phone communication data in voice.

Hereinafter, embodiments of the present invention will be described in detail with reference to the accompanying drawings.

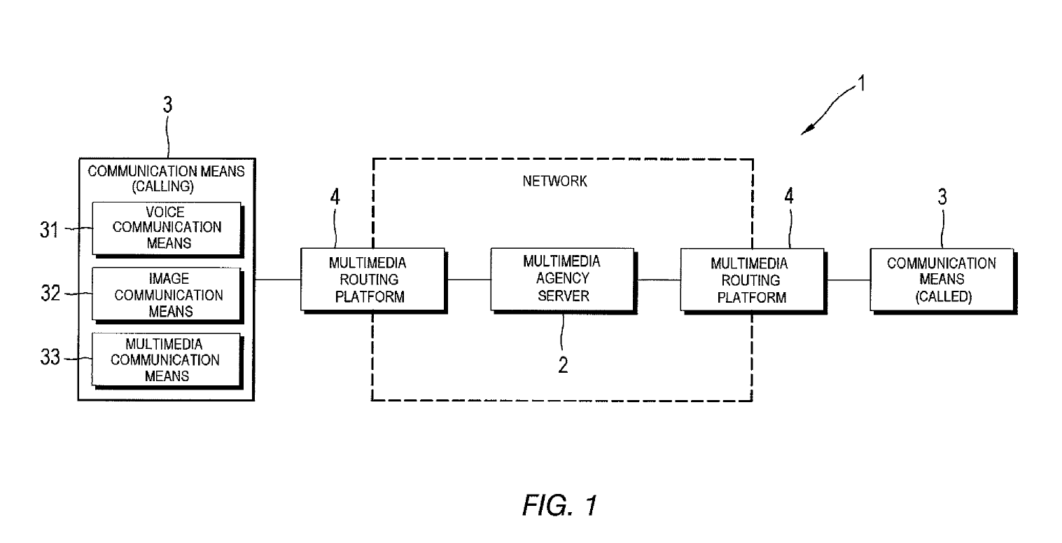

FIG. 1 shows a configuration of a multimedia integrated communication system 1 according to the first embodiment of the present invention.

The multimedia integrated communication system (hereinafter, referred to as MICS) 1 may include a multimedia agent server (hereinafter, referred to as MAS) 2, a communication means 3, and a multimedia routing platform (hereinafter, referred to as MRP) 4.

In one embodiment of the present invention, multimedia communication can be made by linking fittest voice communication and fittest image communication using at least one communication means 3. For example, a user makes a voice call with an opponent using a cellular phone, and at the same time makes a video call through a PC monitor of a different kind. The agency server 2 may install a platform₍₃₎ to various multimedia₍₁₎ communication means₍₂₎ of a user to control their communication, and provides a multimedia integrated communication system₍₈₎ and a communication method₍₉₎ using the same, which connects a call to a fittest multimedia communication routing₍₇₎ by grasping user communication environment information₍₅₎ of a user through the platform and then analyzing communication environments of originator and recipient for a call request₍₆₎ of the user. In particular, the fittest multimedia communication routing is a fittest network communication routing through a multimedia communication service is made in a way that, if an originating side transmits a signal through each voice and image routing, a receiving side conducts synchronization₍₁₀₎ for it. Terms used in embodiments of the present invention are defined as in the following Table 1 through the above footnotes (1) to (10).

TABLE 1

| No. | Terms | | Description |
|---|---|---|---|
| 1 | Multimedia | | Capable of multiplexing voice and image data by coupling at |
| | | | least two kinds of media such as phone, radio, TV and PC to |
| | | | transmit them in one line, and configured with voice + data |
| | | | (moving image, moving picture, static image, text and so on). |
| 2 | Communica- | Voice | Equipped with a transceiver such as a wire phone, a cellular |
| | tion Means | | phone, an Internet phone, a software phone and so on. |
| | | Image | Equipped with a display and a camera such as PC, notebook, |
| | | | D-TV and so on. |
| | | Multi- | Combined type of voice communication means and image |
| | | media | communication means, such as a mobile phone (cellular phone, |
| | | | PCS, WLAN phone, DMB phone and so on), IP display phone, |
| | | | PC software phone and so on. |

| | | |
|---|---|---|
| 3 | Platform | Controlling a communication means to connect a call to a fittest |
| | | multimedia communication routing, classified into H/W type |
| | | linked with the communication means and S/W type installed to a |
| | | communication terminal. |
| 4 | Agency server | Managing various communication environment information of |
| | | user, and controlling a platform for connection to a fittest |
| | | multimedia communication routing. |
| 5 | Communication | Grasping information related to phone number, communication |
| | environment | means charge system, communication quality and so on through |
| | information grasping | the MRP installed to the communication means of a user, or |
| | | allowing direct input of the user. |
| 6 | Call request | Phone number input or click to dial |
| 7 | Fittest multimedia | FMR (Fittest Multimedia Routing) = FCR (Fittest Call Routing, |
| | communication routing | voice) + FPR (Fittest Picture Routing, image). Combination of |
| | | voice communication routing and image communication routing |
| | | closest to a priority condition value (quality/charge/security) |
| | | depending on correlation of user. |
| 8 | Multimedia integrated | MICS (Multimedia Integrated Communication System): MAS |
| | communication system | (agency server) + MPR (platform) + multimedia communication |
| | | means |
| 9 | Communication | When a multimedia communication environment of user is 1 or |
| | method | above, communication routings of voice and image are |
| | | respectively analyzed to make multimedia communication |
| | | through a fittest communication routing. Namely, at least one |
| | | communication routing (wire, wireless, cable, wireless LAN, |
| | | Internet) is used to transmit multimedia classified into voice and |
| | | image, and the transmitting and receiving sides synchronize each |
| | | signal to enable multimedia communication. |
| 10 | Synchronization | Detecting hook-off of the recipient voice communication means |
| | | to display image information on a display of the image |
| | | communication means. |

In one embodiment, the communication means 3 includes a voice communication means 31, an image communication means 32, and a multimedia communication means 33. A user may use the voice communication means 31 and the image communication means 32 according to the control of the agency server 2, or use the multimedia communication means 33 to make a voice and image call.

The network employed in one embodiment of the present invention allows transmission of multimedia communication data, and it includes a wire communication network (e.g., PSTN), a wireless communication network (e.g., a mobile communication network), a wire/wireless Internet, and a cable network.

The platform 4 may play a role of an integrated communication interface of multimedia communication data composed of voice and image signals. The platform 4 includes a hardware (H/W) platform 41 for controlling the communication means 3 and CPE (Customer Premises Equipment) of the communication means such as PBX (Private Branch Exchange), G/W (Gateway) and WPBX (Wireless PBX), and a software (S/W) platform 42 directly installed to the user communication means 3 to control a communication routing.

In particular, FMR (Fittest Multimedia Routing) may allow multimedia communication by means of an optimized communication means and an optimized communication routing in a way that the agency server 2 receives a call request of an originator and then analyzes communication environment information of the originator and recipient such as communication means, charge system, quality and security. Thus, though an originator requests a multimedia call to an opponent using a mobile phone (for voice communication) and a PC (for image communication), the communication means 3 of the originator can be changed into a wire phone and a PC according to the calculation of FMR of the agency server 2. As mentioned above, the MICS 1 may integrally control various communication means and communication methods that compose the communication environment of the users, and then finds out a fittest one among them to give multimedia communication service using it.

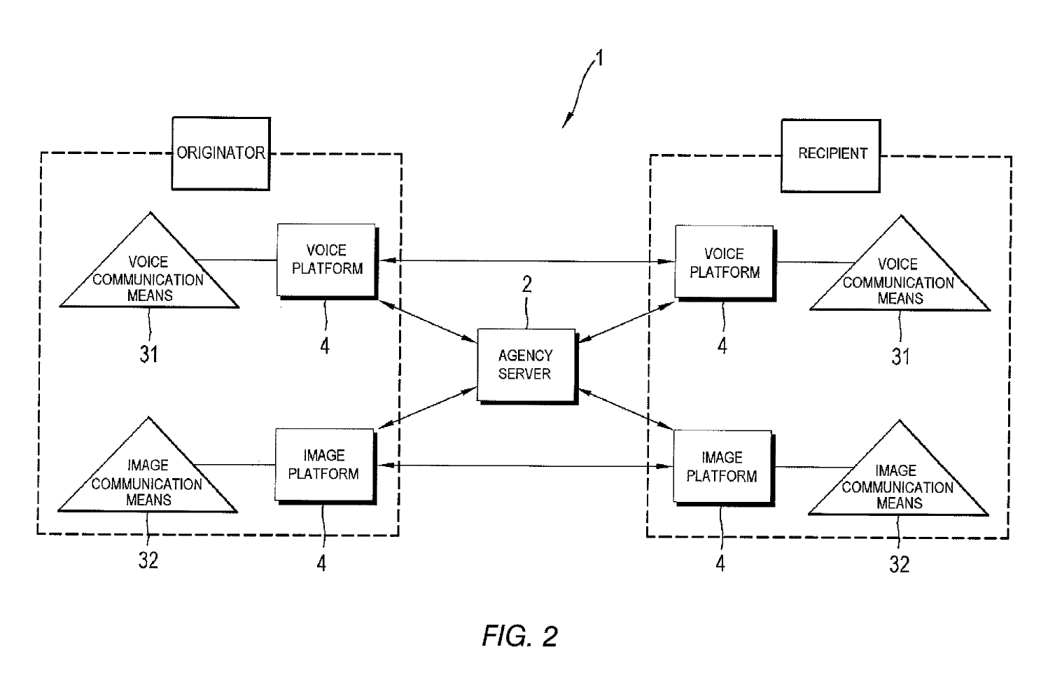

FIG. 2 schematically shows a concept of the communication environment according to one embodiment of the present invention in which voice and image are separated.

<Call Request>

An originator inputs a phone number using his/her own communication means 3 or clicks to dial with executing the S/W platform (MRP) 41 to request a multimedia call.

<Analysis of Fittest Multimedia Communication Routing>

The platform 4 transmits phone number information to the MAS 2 to request a fittest multimedia communication routing. The agency server 2 analyzes priority information according to correlation and multimedia communication environments of the originator and the recipient and then calculates a fittest multimedia communication routing.

<Process of Connecting Voice Communication>

The agency server 2 transmits fittest voice communication routing control information to the platform 4 of the originator and the recipient. Here, though the originator inputs an opponent phone number in a mobile phone to request a call with the opponent, the communication means of the originator may be changed from the mobile phone to a wire phone by means of the agency server 2 to connect the call. The platform 4 of the originator and the recipient connects the voice communication routing according to the received fittest voice communication routing control information.

<Process of Connecting Image Communication>

The agency server 2 transmits fittest image communication routing control information to the platform 4 of the originator and the recipient. Here, though the originator inputs an opponent phone number in a mobile phone to request an image call with the opponent, the communication means of the originator may be changed from the mobile phone to a PC by means of the agency server 2 to connect the call. The platform 4 of the originator and the recipient connects the image communication routing according to the received fittest image communication routing control information.

<Recipient Call Receiving Information>

The voice platform 4 of a recipient recognizes hook-off information of the voice communication means 31 of the recipient and then transmits the hook-off information to an image platform 4 of the originator and the recipient according to the control of the agency server 2 to request initiation of image communication according to start of voice communication. In other case, the recipient may click a receipt confirmation button on the image platform 4 and then inform the image platform 4 of the originator that the image communication routing is set, according to the control of the agency server.

<Execution of Multimedia Communication>

The originator and the recipient progress voice communication through their own voice communication means 31 (e.g., a transmitter and a receiver), and at the same time progress image communication through the image communication means 32 (e.g., displays).

<Quit>

If the voice communication of the originator and the recipient is ended, hook-on information of the originator and the recipient is transmitted to the voice platform 4 of the originator and the recipient to request quitting the image regeneration. In other case, the originator or the recipient may request to quit image regeneration by clicking an image regeneration quitting button on the image communication means 32.

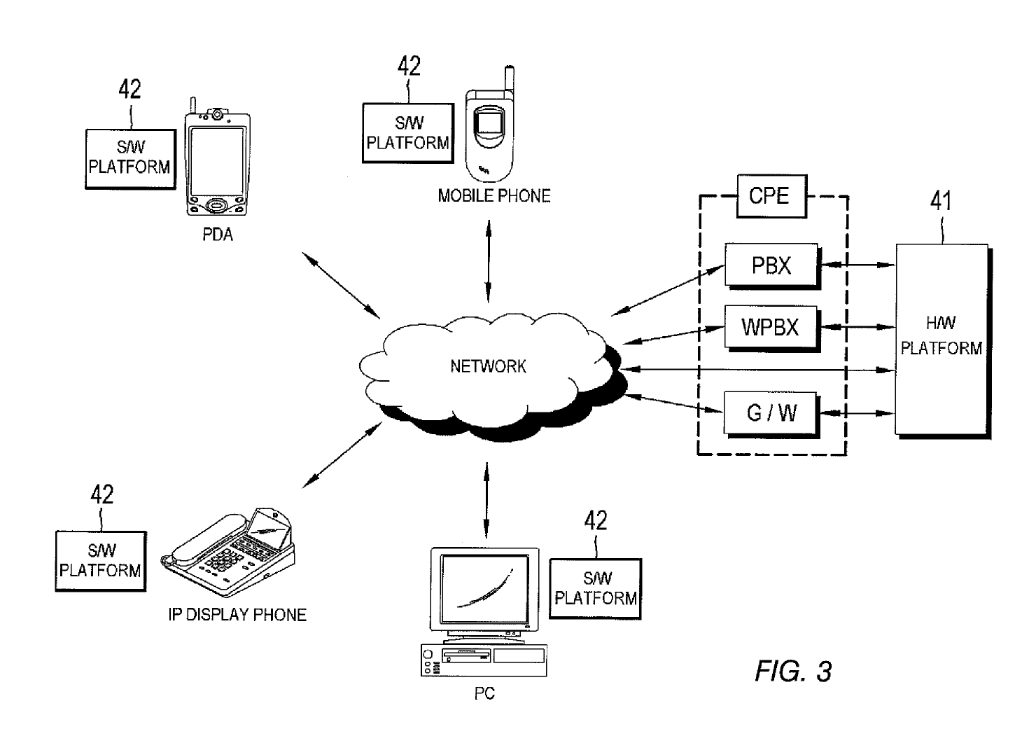

FIG. 3 schematically shows a configuration of the environment of the multimedia communication means 33 and the platform 4 according to one embodiment of the present invention. The multimedia communication means 33 may be a single-type communication means having a display function, a camera function and a S/W downloading function, or a linking communication means (e.g., PBX, WPBX or G/W as a CPE communication equipment) linked to a H/W platform to allow multimedia communication, as shown in the following Table 2 as examples.

TABLE 2

| Communication means | | Functions/characteristics |
|---|---|---|
| Single-type | Mobile | Communicating through a wireless communication network, and |
| | phone | capable of image communication through a wireless Internet using |
| | | 3G technique. |
| | PDA | Having a mobile phone function through a wireless communication |
| | (WLAN | network, and capable of multimedia communication through a |
| | phone) | wireless Internet of WLAN at a hot spot (A/P installation region). |
| | IP display | Capable of multimedia communication using IP (Internet Protocol) |
| | phone | through Internet |
| | PC | Capable of multimedia communication through a software phone |
| | (Software | program installed thereto (requiring a camera and a headset). |
| | phone) | |
| Linking- | PBX | Providing a voice-dedicated extension phone through an extension |
| type | | exchange for wire communication, and H/W platform controls PBX |
| | | to give multimedia communication in linkage with S/W platform. |
| | WPBX | Integrating a mobile communication base station and an extension |
| | (wireless | exchange, a mobile phone can be used as an extension wire phone, |
| | PBX) | H/W platform controls a mobile phone through WPBX to allow |
| | | multimedia communication. |
| | G/W | An equipment required for Internet phone, providing Internet phone |
| | (Gateway) | service in connection to G/K (Gate Keeper), H/W platform controls |
| | | Internet phone through G/W to allow multimedia communication. |

In addition, the platform 4 is provided with a communication environment information registration function, a communication means control function, a fittest communication routing connecting function, a charge data generating function, a P2P function, and an image data storing function, as shown in Table 3 as an example.

TABLE 3

| Platform | Functions/characteristics |
|---|---|
| H/W | H/W platform accesses CPE communication |
| platform | means (API connection) and controls |
| | CPE communication means by means of |
| | mutual linkage. H/W platform checks |
| | fittest routing information through |
| | the agency server using the phone number |
| | information input through the CPE |
| | communication means, and then controls CPE |
| | to allow multimedia communication. |
| S/W | A user accesses the agency server 2 |
| platform | using the multimedia communication means |
| | 33 and downloads and installs program. |
| | If a multimedia call is requested (by |
| | input or click of a phone number) |
| | while S/W platform is executed, S/W platform |
| | 42 controls the communication means |
| | to allow multimedia communication by |
| | means of the control of the agency server 2. |

As an effect of linkage between the H/W platform 41 and the S/W platform 42, the multimedia communication means 33 having no physical linkage is integrated through the platform 4 so that a user may converge multimedia means 33 of various networks to always use the optimized multimedia communication service.

The G/W shown in FIG. 3 connects both communication networks so that a telephone user and a phone service subscribed user (or, a subscriber) may communicate with each other, so it allows at least two communications of the same kind or different kinds to be interconnected and exchange information.

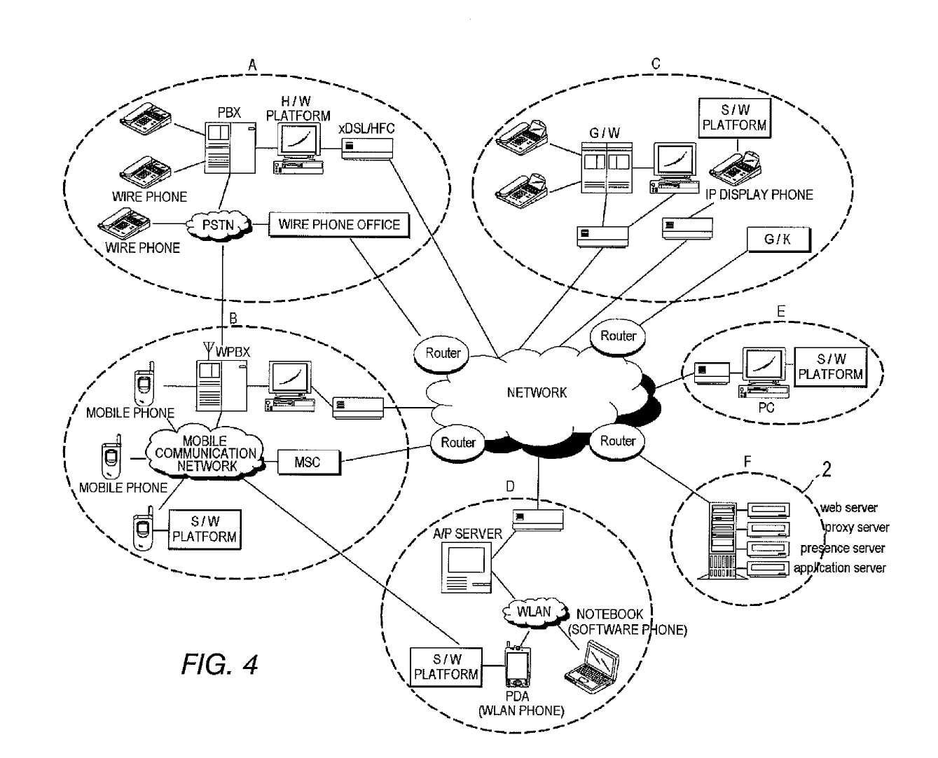

FIG. 4 shows a configuration of the entire network according to the first embodiment of the present invention.

A. PSTN configuration: including a wire phone, a wire phone exchange, a wire communication network, PBX, H/W platform, and xDSL/HFC.
H/W platform: a function for connecting a fittest communication routing by controlling PBX in linkage with the MAS through IP network.
xDSL/HFC: a function for connecting xDSL (x Digital Subscriber Line) and HFC (Hybrid Fiber Coax) communication means to the network.

B. Configuration of mobile communication network: including a mobile phone, MSC, WPBX, H/W platform, xDSL/HFC, and S/W platform.
MSC: linked to the agency server 2 through IWF (Inter Working Function) and Gateway using Mobile Switching Center.
H/W platform (MRP): a function for connecting a fittest communication routing by controlling WPBX in linkage with the agency server 2 through IP network.
S/W platform (MRP): capable of giving a software phone, and connecting a fittest communication routing by controlling a communication means in linkage with the agency server 2 through IP network.

C. Configuration of IP phone network: including IP display phone, G/W, G/K, H/W platform, and xDSL/HFC.
IP display phone: supporting image communication as a VoIP (Voice over IP) function through IP network, and has a protocol such as H.323, SIP, MGCP, and MEGACO/H.248.
H/W platform: a function for connecting a fittest communication routing by controlling G/W in linkage with the agency server 2 through IP network.

D. WLAN: including PDA, notebook, S/W platform, A/P server, and xDSL/HFC.
PDA: capable of connecting a mobile communication network and WLAN simultaneously, and capable of multimedia communication with a software phone function by means of S/W platform installed thereto.
notebook: connected to WLAN, and capable of multimedia communication with a software phone function by means of S/W platform installed thereto.
A/P (Access Point) Server: connecting Internet by authenticating a communication means (e.g., PDA or notebook) connected through WLAN.

E. Configuration of Internet: including PC and xDSL/HFC.

F. Configuration of the agency server: including web server, presence server, proxy server, and application server.
Web server: managing users of multimedia communication service through a homepage.
Presence server: presence information and managing communication environment information of user.
Proxy server: controlling call connection of a software phone (e.g., a mobile phone, PDA, notebook and PC) of S/W platform.
Application server: managing other applications.

G. User multimedia communication environment: including a combination of various multimedia communication means of the above A to E.

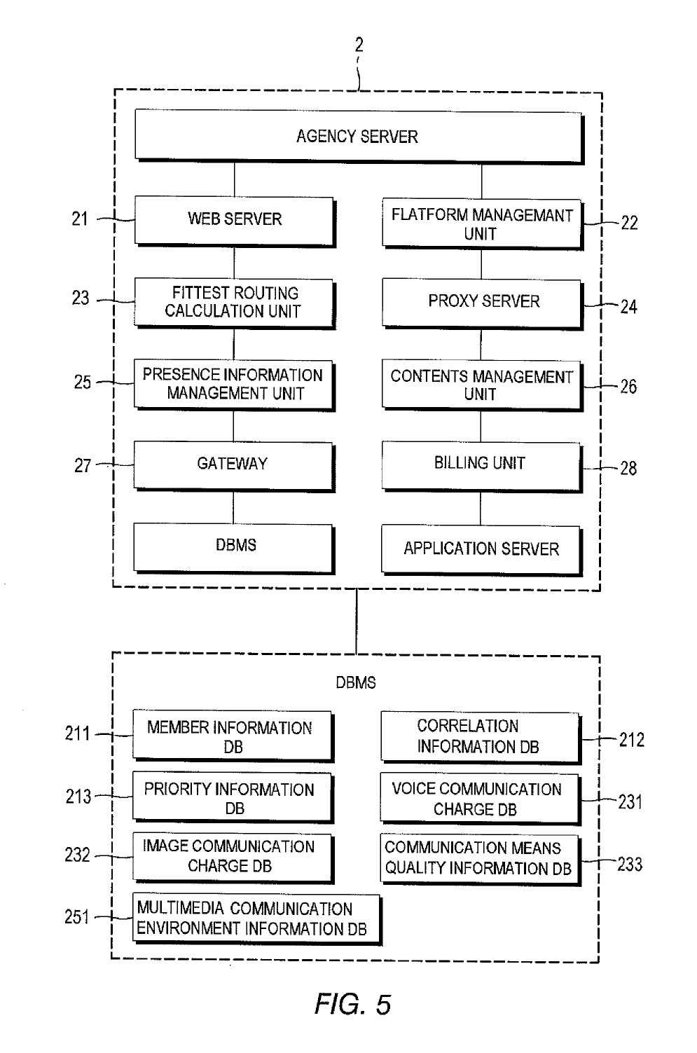

FIG. 5 shows an inner configuration of the agency serve 2 according to one embodiment of the present invention. The agency server includes a web server 21, a platform managing unit 22, a fittest routing calculating unit 23, a proxy server 24, a presence information managing unit 25, a contents managing unit 26, a gateway 27, a billing unit 28, DBMS, and an application server. The agent server (MAS) 2 generally controls the above components 21 to 28, and provides multimedia communication service according to a fittest communication routing (FMR) to an originator and a recipient. A user should receive user identification (AAA=Authentication, Authorization, Accounting) through the agency server 2 in order to get this service.

The web server 21 allows a user to join as a member and stores registered personal information in DB. In addition, it receives information of various communication means (e.g., a wire phone, a mobile phone, an Internet phone, PC and so on) used for the multimedia communication service from a user, and allows the user to set calculation criterion information (e.g., charge, quality, and security) for the fittest communication routing.

The platform managing unit (MRP server) 22 collects presence information of the communication means 3 by managing the platform 4 of the user, controls connection to a fittest multimedia communication routing, and generates a charge data.

The fittest routing calculating unit (FMR server) 23 calculates a fittest voice communication routing and a fittest image communication routing respectively based on communication environments of the user. In order to calculate a fittest routing, the multimedia communication environment information (or, the presence information) of the user and the calculation criterion information set by the user are referred to.

The proxy server 24 plays a role of processing protocol (H.323, SIP, MGCP, MEGACO/H.248), call connection by control of a software phone of signaling, routing, cal control S/W platform 42, and Direct & Redirect server.

The presence information managing unit (Presence server) 25 manages multimedia communication environment information collected by the platform managing unit 22 and user presence information (e.g., On, Off, Busy, Away, Don't Disturb, an so on). The contents managing unit (Contents Server) 26 plays functions of data conversion (image conversion function), provision of multimedia composing tool, and contents data push. The gateway 27 is composed of signaling H/W and Media G/W and supports linkage to other systems. The billing unit (Billing server) 28 is a billing server and plays a role of a clearing house for processing backward communication.

The DBMS (DB Management Server) is database in which user history information, user correlation information, user priority information, user communication means and communication environment information, and communication service provider information (e.g., charge table, quality table) are stored.

The following Table 4 is a pattern of multimedia communication service of the agency server 2 according to one embodiment of the present invention.

TABLE 4

| | | | |
|---|---|---|---|
| Fittest | Voice | Forward | Communication for connecting a call from a |
| multimedia | | communication | communication means of an originator to a |
| communication | | | communication means to a recipient. |
| (FRM) | | | |
| | | Backward | Communication for connecting a call from a |
| | | communication | communication means of a recipient to a |
| | | | communication means to an originator. |
| | Image | P2P image | Communication for transmitting/receiving image |
| | | communication | information (moving picture, image file, text) |
| | | | with operating MRP of originator and recipient as |
| | | | P2P, the image information being possessed in |
| | | | each platform. |
| | | Mediation image | Communication for transmitting/receiving image |
| | | communication | information (image file, text) of originator and |
| | | | recipient by pushing it to the platform 4 by the |
| | | | agency server, the image information being |
| | | | stored in DB of the agency server. |

The following Table 5 exemplarily shows protocol patterns of the communication service provided by the agency server 2.

TABLE 5

| Kind of protocol | | Structure | Description |
|---|---|---|---|
| FRM request protocol | | Originator MRP | Protocol structure sent when the originator |
| | | information + | platform 4 requests a multimedia fittest routing |
| | | originator phone | to the agency server |
| | | number + recipient | originator phone number: a phone number of a |
| | | phone number + | communication terminal with which the originator |
| | | FMR request | attempts a call. |
| | | signal | recipient phone number: a phone number input |
| | | | by the originator. |
| Forward FCR protocol | | Forward FCR | Protocol structure for sending the fittest voice |
| | | signal + recipient | communication routing information calculated |
| | | phone number + | by the agency server to the platform 4. |
| | | voice | recipient phone number: FCR phone number of |
| | | communication | the recipient, changeable from the originally |
| | | control signal | input phone number. |
| Backward | Originator | Backward FCR | recipient sending phone number: a phone |
| FCR | MRP | signal + recipient | number of the sending communication means |
| protocol | | sending phone | of the recipient corresponding to backward |
| | | number + | FCR. |
| | | backward voice | backward voice call connection standby |
| | | call connection | signal: signal instructing standby for a sending |
| | | standby signal | call at the recipient. |
| | Recipient | Backward FCR | calling phone number: a phone number that |
| | MRP | signal + calling | will be sent to the originator from the recipient |
| | | phone number + | corresponding to backward FCR. |
| | | backward voice | backward voice call connection control signal: |
| | | call connection | a control signal instructing call connection to |
| | | control signal | the originator from the recipient. |
| Fittest FPR | P2P | Calling MRP IP | Protocol structure for sending the fittest image |
| protocol | | address | communication routing calculated by the |
| | | endowment + | agency server to the transmitting/receiving |
| | | called MRP IP | MRP (peer) |
| | | address | calling MRP IP address endowment: the platform |
| | | endowment + FPR | 4 operates as Server/Client as IP address for |
| | | information + | P2P communication. |
| | | image call standby | called MRP IP address |
| | | signal | endowment: the platform 4 operates as |
| | | | Server/Client as IP address for P2P |
| | | | communication. |
| | | | FRP information: image information to |
| | | | be communicated by the originator and |
| | | | the recipient, including moving picture/ |
| | | | moving image/static image/text. |
| | | | image call standby signal: a signal indicating |
| | | | standby till a hook-off signal of the recipient |
| | | | is input. |
| | Agency | Push signal + FPR | Push signal: a signal indicating to distribute |
| | | information | data to the platform 4 of the originator and the |
| | | | recipient by the agency server. |
| | | | FRP information: image information to be |
| | | | distributed to the originator and the recipient, |
| | | | including moving image/static image/text. |
| Privacy | Originator | Privacy protection | signal for changing the changed recipient |
| protection | MRP | signal + signal for | phone number into the original number: a |
| protocol | | changing the | signal indicating to change a phone number of |
| | | changed recipient | the recipient, changed for preventing exposure |
| | | phone number into | of location information of the recipient, into the |
| | | the original | originally input phone number in case the |
| | | number | phone number originally input by the originator |
| | | | is changed by FCR. |
| | Recipient | Privacy protection | signal for changing the changed originator |
| | MRP | signal + signal for | phone number into the original number: a |
| | | changing the | signal indicating to change a phone number of |
| | | changed originator | the originator communication means, changed |
| | | phone number into | for preventing exposure of location information |
| | | the original | of the originator, into the originally input |
| | | number + original | phone number in case the phone number |
| | | phone number | originally input by the originator is changed by |
| | | | FCR. |

Hereinafter, DB structure of the multimedia integrated communication system 1 according to one embodiment of the present invention will be described. The agency server 1 includes a member information DB 211, a correlation information DB 212, a priority information DB 213, a voice 5 communication charge DB 231, an image communication charge DB 232, a communication means quality information DB 232, and a communication environment information DB 251. The following Table 6 shows a structure of the member information DB, but not limitedly.

TABLE 6

| Items of member | |
|---|---|
| information DB | Description |
| User information | Basic information of persons/ |
| | companies (ID, name, address, phone |
| | number, mail address and so on) |
| Communication | Phone number, specification (e.g., |
| means information | the kind of display, existence of |
| | camera, codec and so on), communi- |
| | cation charge system and so on are |
| | registered as communication means |
| | information of a member. (e.g., |
| | cellular phone: phone number, S/W |
| | platform ID, secret number, specifi- |
| | cation, the kind of communication |
| | charge system |
| Condition | Information used as a criteria of |
| information | priority for selecting a platform. |
| | E.g., voice communication routing = |
| | charge > quality Image communication |
| | routing = charge > quality |
| Correlation | Correlation information of a user, |
| information | stored as a format of personal address |
| | book, and referred for calculating |
| | a fittest communication routing. |

The following Table 7 shows an example of data of the correlation information DB 212, but not limited thereto. A user may register the correlation information in his/her own address book in the agency server 2, and this information is used for calculating FMR information.

TABLE 7

| User of | Customer list | | Colleague list | | Family/friend list | |
|---|---|---|---|---|---|---|
| correlation | Name | Mobile phone | Name | Mobile phone | Name | Mobile phone |
| User A | Kim, XX | 011-XXX-XXXX | Lee, XX | 011-XXX-XXXX | Park, XX | 011-XXX-XXXX |
| User B | . . . | . . . | . . . | . . . | . . . | . . . |

The following Table 8 exemplarily shows data of the priority information DB 213, but not limited thereto. The agency server 2 may automatically calculate FMR by referring to the correlation information DB 212 and the priority information DB 213. Seeing the Table 8, in case of an image call where personal privacy is important, a condition is designated so that an image call can be connected only when it is very necessary. For this purpose, without special effort of the user, multimedia communication suitable for the user is automatically connected. For example, if an originator makes a call to an opponent of a user A and the originator is registered as a customer of the recipient A, an ‘edited image’ condition value is automatically calculated so that the edited image information is displayed through the fittest communication means in the current multimedia communication environment of the originator, and a company may express it as an advertising image.

TABLE 8

| Classification/correlation | | Customer | Colleague | Family/friend | Default |
|---|---|---|---|---|---|
| User A | Voice | Quality > | Quality * | Charge > quality | Quality > |
| | communication | charge | charge | | charge |
| | Image | Quality * | Charge > | Charge > quality | Quality > |
| | communication | charge | quality | | charge |
| | Image | Edited image > | Moving | Moving picture > | Null |
| | information | moving | picture > | edited image | |
| | | picture | edited image | | |
| User B | . . . | . . . | . . . | . . . | . . . |

The following Table 9 exemplarily shows data of the voice communication charge DB 231, but not limited thereto. The agency server 2 refers to communication charges according to a communication charge system of each communication service provider in order to calculate a fittest voice communication routing.

TABLE 9

| | Communication service | Provider A | Provider B | Provider C | Provider D |
|---|---|---|---|---|---|
| Charge system | provider receiving place | 02 | 082 | 011 | 070 |
| Basic charge | To a local phone | 39 | 39 | 360 | 39 |
| system | | | | | |
| | To a distant phone | 261 | 253 | 360 | 39 |
| | To a mobile phone | 266 | 266 | 360 | 225 |
| | To an Internet phone | 39 | 39 | 360 | 20 |
| Special charge | . . . | . . . | . . . | . . . | . . . |
| system | | | | | |
| Fixed charge | . . . | . . . | . . . | . . . | . . . |
| system | | | | | |

The following Table 10 exemplarily shows data of the image communication charge DB 232, but not limited thereto. The agency server 2 refers to communication charges according to a communication charge system of each communication service provider in order to calculate a fittest image communication routing.

TABLE 10

| | | PC | | Mobile | | |
|---|---|---|---|---|---|---|
| CallingCalled | | communication | Internet | A | B | WLAN |
| PC communication | | 0 | 0 | 6.5 | 6.5 | 2.5 |
| Internet | | 0 | 0 | 6.5 | 6.5 | 2.5 |
| Mobile | A | 6.5 | 6.5 | 6.5 | 6.5 | 6.5 |
| | B | 6.5 | 6.5 | 6.5 | 6.5 | 6.5 |

| | | | | | |
|---|---|---|---|---|---|
| WLAN | 2.5 | 2.5 | 6.5 | 6.5 | 0 |

The following Table 11 exemplarily shows data of the communication means quality information DB 233, but not limited thereto. The agency server 2 refers to quality information of each communication means in order to calculate a fittest image communication routing.

TABLE 11

| Classifi- | Called- | | | | VoIP | | | |
|---|---|---|---|---|---|---|---|---|
| cation | calling | PSTN | Mobile | | (MoIP) | | WLAN | |
| Voice(MOS | PSTN | 4.1 | 3.4 | | 3.9 | | 3.6 | |
| value) | | | | | | | | |
| | Mobile | 3.4 | 3.4 | | 3.4 | | 34 | |
| | VoIP | 3.9 | 3.4 | | 3.9 | | 3.6 | |
| | WLAN | 3.6 | 3.4 | | 3.6 | | 3.6 | |
| Image | PSTN | 56 Kbps | 56 | Kbps | 56 | Kbps | 56 | Kbps |
| (transmis- | | | | | | | | |
| sion | | | | | | | | |
| rate) | | | | | | | | |
| | Mobile | 56 Kbps | 2 | Mbps | 2 | Mbps | 2 | Mbps |
| | MmoIP | 56 Kbps | 2 | Mbps | 10 | Mbps | 2.4 | Mbps |
| | WLAN | 56 Kbps | 2 | Mbps | 2.4 | Mbps | 2.4 | Mbps |

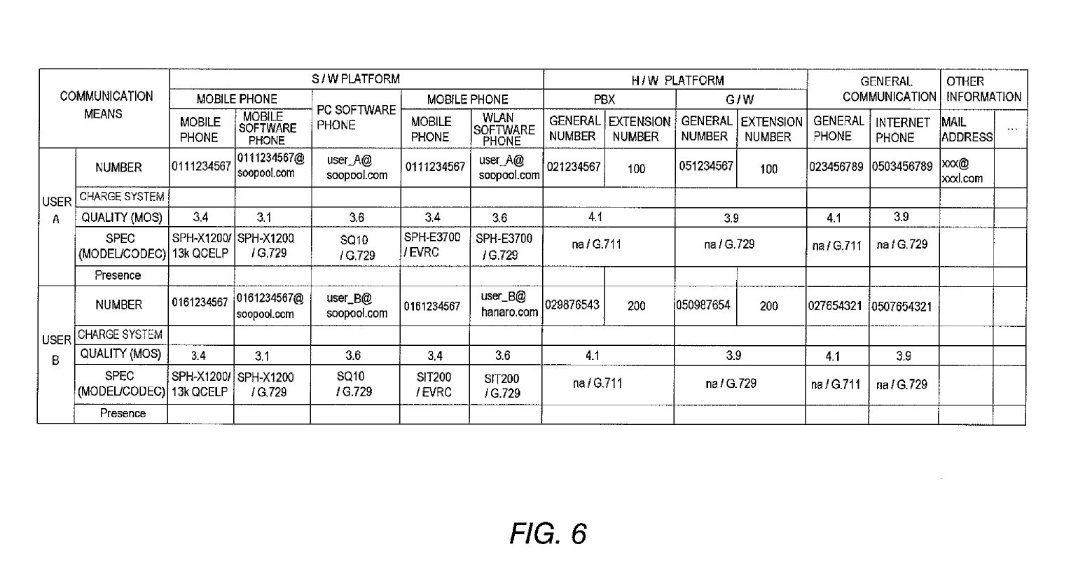

FIG. 6 exemplarily shows data of the communication environment information DB 251, but not limited thereto. The communication environment information DB 251 is a table in which information related to communication environment information (phone number, specification, quality, communication charge system, presence information) is collectively gathered. (the presence information: information related to presence of the communication means such as On, Off, Busy, Away, Don't disturb).

The following Table 12 exemplarily shows data of the billing table, but not limited thereto. In case of backward communication, a calling subject and a billed subject are different, so a clearing house for the communication charge is required. An originator can provide a part of call charge reduction as a compensation for sharing the communication environment information of a recipient.

TABLE 12

| Originator | Name | |
|---|---|---|
| information | ID | Kim, XX |
| Calling | Original calling communication means | |
| information | Actual connection communication means | |
| Called | Original calling communication means | |
| information | Actual connection communication means | |
| Call charge | Call start time | |
| | Call end time | |
| | Communication charge system | |
| | Original call charge | |
| | Actual call charge | |
| | Reduction | |
| Billed subject | | |
| Share | Originator | |
| compensation | Recipient | |

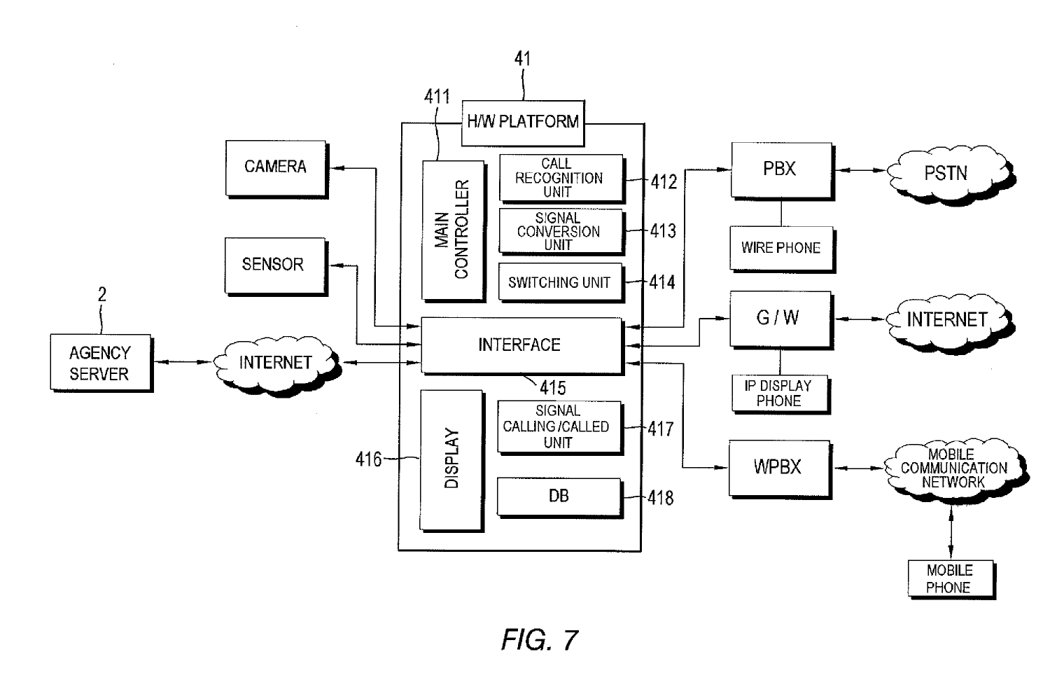

FIG. 7 shows an inner configuration of the H/W platform 41 according to one embodiment of the present invention.

Configuration of H/W Platform

Main controller 411: integrating and generally controlling CPE connected to the H/W platform 41, and realizing fittest multimedia communication in linkage with the agency server (MAS). Call recognizing unit 412: recognizing a calling number (Caller-ID) of a call received in CPE. Signal converting unit 413: signal conversion of transmitted or received data.

Switching unit 414: switching and connecting a communication channel.

Interface 415: inputting/outputting data in linkage with various external devices.

Display 416: displaying moving picture, moving image, static image, text and so on.

Signal calling/called unit 417: transmitting a call or receiving a received call.

DB 418: storing operation S/W, protocol, billing data, phone number information, user sensor ID information, user input data and so on.

CPE control of H/W MRP: controlling a call in linkage with CPE through API.

PBX: the H/W platform 41 controls PBX for fittest routing connection in order to convert a communication routing of an extension phone.

153WPBX: the H/W platform 41 controls a mobile phone connected to WPBX for fittest routing connection in order to convert a communication routing.

G/W: the H/W platform 41 controls an IP display phone connected to G/W for fittest routing connection in order to convert a communication routing.

Sensor: connecting to Tag (ID card, RFID and so on) of a user, and the H/W platform automatically registers user communication environment information through ID of a user accessing to the sensor.

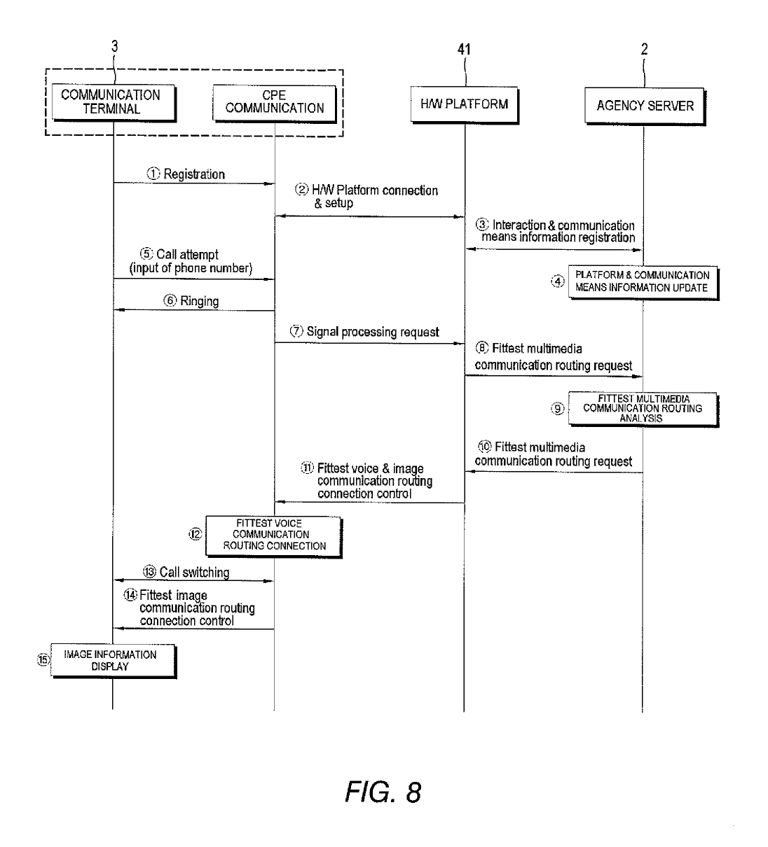

FIG. 8 shows a process function of the H/W platform 41 according to one embodiment of the present invention. For convenience, it is assumed that a display image is expressed through the H/W platform 41 while making a voice call with a general wire phone (or, an extension phone).

\textcircled{1} Registration: communication terminals (wire phone, mobile phone, IP display phone) are respectively registered in CPE (customer premises equipment).

\textcircled{2} H/W platform connection and setup: the H/W platform 41 is connected (using API) to the CPE communication means and set up (adjusting CPE program) to register the communication means information (CPE information, the communication terminal information) to the H/W platform 41.

159\textcircled{3} Mutual linkage and communication means registration: the H/W platform 41 and the agency server 2 are mutually interacted, and the communication means information (CPE communication information (communication line information, communication charge system information, extension number information, other information), and communication terminal information) is registered in the agency server 2.

\textcircled{4} Platform and communication means information update: the agency server (MAS) registers the input information of the H/W platform (provision of a new ID, service setup), and the CPE communication means and communication terminal information is updated.

\textcircled{5} Call attempt (input of a phone number): a user attempts a call by inputting a phone number through an extension phone (wire phone, Internet phone, mobile phone) connected to CPE.

\textcircled{6} Ringing: CPE sends a ring signal to the extension phone.

\textcircled{7} Request for call processing: CPE relays a call to the H/W platform 41 without directly processing the call.

\textcircled{8} Request of FMR (Fittest Multimedia Routing): the H/W platform 41 transmits FMR request protocol (caller MRP information+caller phone number+recipient phone number+FMR request signal) to the agency server 2 to request FMR.

\textcircled{9} FMR analysis: the agency server 2 analyzes communication environments of the originator and the recipient and the condition information (correlation information, priority information) through the received information and calculates a fittest multimedia communication routing. Here, the fittest routing is a forward communication connected from the originator to the recipient, and the image will be described based on P2P as an example.

\textcircled{10} FMR response: the agency server 2 transmits forward FCR protocol (forward FCR signal+recipient phone number+voice communication connection control signal) and fittest FPR protocol (P2P=sending MRP IP address endowment+receiving MPR IP address endowment+FPR information+image call standby signal) to the H/W platform 41<FMR=FCR (fittest call routing)+FPR (fittest picture routing)>.

\textcircled{11} Fittest voice and image communication routing connection control: the H/W platform 41 analyzes the received FMR information and controls CPE to send a call to the fittest voice communication routing (FCR).

\textcircled{12} Fittest voice communication routing connection: CPE sends a call according to the control of the H/W platform (here, call sending of PBX extension phone).

\textcircled{13} Call switching: if the recipient receives a call, CPE connects the call to the extension phone of the originator.

\textcircled{14} Fittest image communication routing connection control: if the agency server 2 senses a receiving hook-off signal of the recipient and controls the image information display, the H/W platform 41 operates as P2P (server/client) to display the image information (the displaying process will be described later).

\textcircled{15} Image information display: the image information is displayed through a display of the H/W platform.

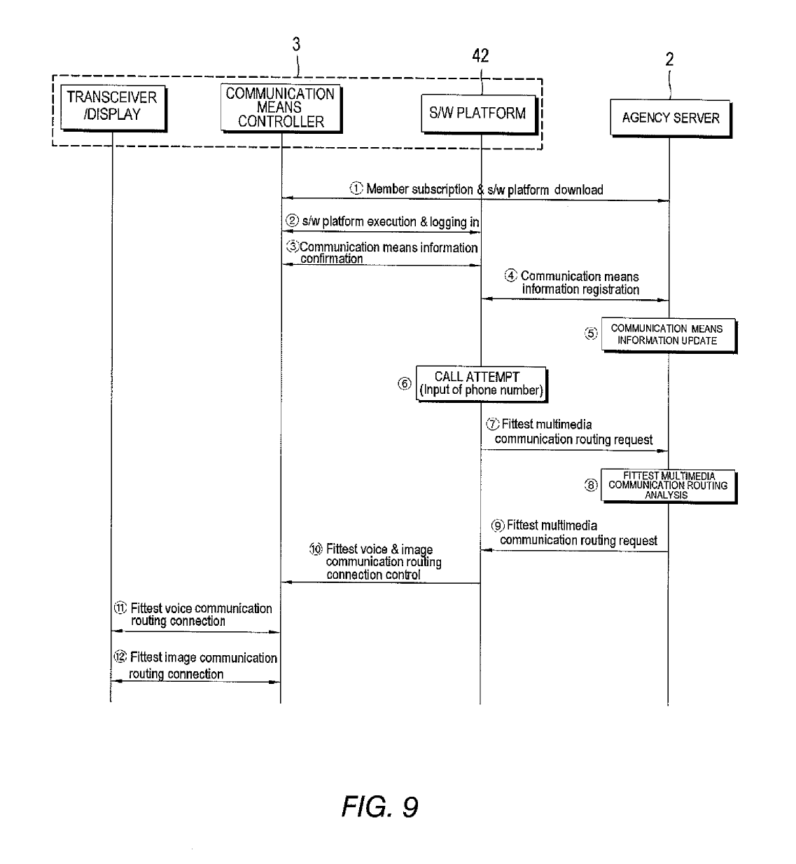

FIG. 9 shows a process function of the S/W platform 42 according to one embodiment of the present invention. For convenience, it is assumed that an image is expressed through a PC display (LCD) with making a voice call using a mobile phone.

\textcircled{1} Member subscription and S/W platform download: a user accesses (using wire/wireless Internet) the agency server 2 using a communication means 3 to join as a member, and downloads a S/W platform 42.

\textcircled{2} S/W platform execution and logging-in: the S/W platform 42 is executed for setting-up and logging-in to the communication means 3.

\textcircled{3} Communication means information confirmation: the S/W platform 42 controls the communication means controller to confirm communication means information (phone number, network).

\textcircled{4} Communication means information registration: the confirmed communication means information is transmitted to the agency server 2. Here, it is assumed that the communication environment of the originator is equipped with a mobile phone and PC together.

\textcircled{5} Communication means information update: the agency server 2 updates the received communication means information of the user.

\textcircled{6} Call attempt (input of a phone number): the user inputs a phone number with executing the S/W platform 42 to attempt a call.

\textcircled{7} Fittest multimedia communication routing (FMR) request: the S/W platform 42 transmits FMR request protocol (caller MRP information+caller phone number+recipient phone number+FMR request signal) to the agency server 2 to request FMR.

\textcircled{8} Fittest multimedia communication routing analysis: the agency server 2 analyzes communication environments of the originator and the recipient and the condition information (correlation information, priority information) through the received information and calculates a fittest multimedia communication routing. Here, the fittest routing is a forward communication connected from the originator to the recipient and the image will be described based on mediation image communication as an example.

\textcircled{9} Fittest multimedia communication routing response: the agency server 2 transmits forward FCR protocol (forward FCR signal+recipient phone number+voice communication connection control signal) and fittest FPR protocol (mediation=PUSH signal+FPR signal) to the S/W platform 42 (FMR=FCR+FPR).

\textcircled{10} Fittest multimedia communication routing connection control: the S/W platform 42 analyzes the received FMR information and controls the mobile phone to send a call to the fittest voice communication routing.

\textcircled{11} Fittest voice communication routing connection: the communication means controller of the mobile phone sends a call according to the control of the S/W platform 42 and connects a voice call.

\textcircled{12} Fittest image communication routing connection: if a receiving hook-off signal of the recipient is received to the S/W platform 42, the agency server 2 pushes the image information to the PC S/W platform 42 of the originator to regenerate it on a display (the displaying process will be described later).

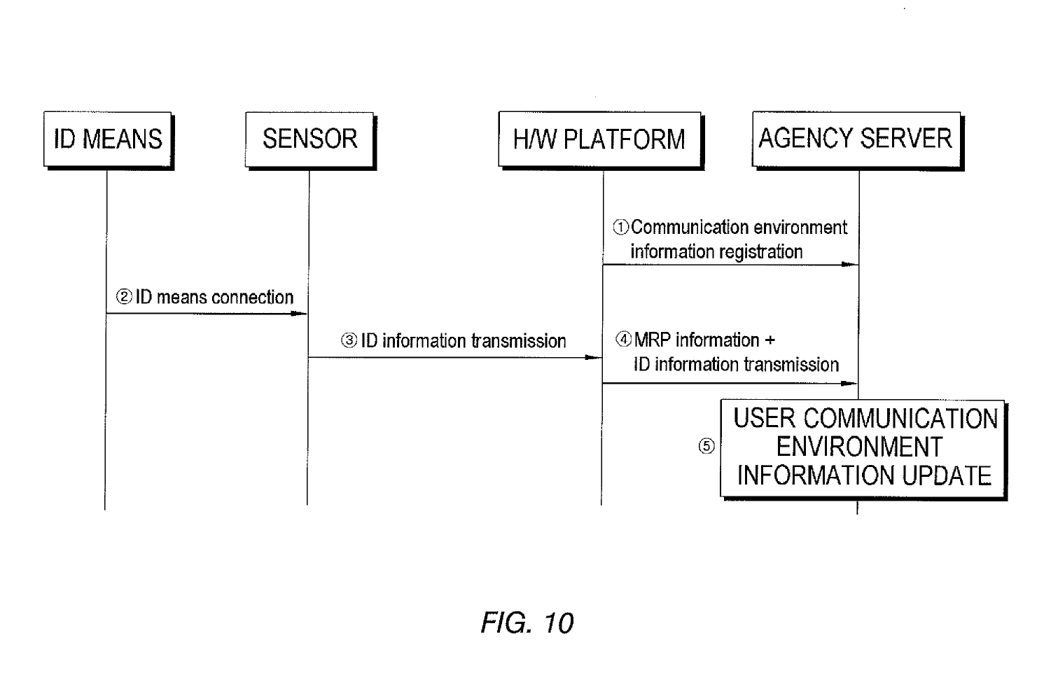

FIG. 10 shows a communication environment information registering process in linkage of the H/W platform and the sensor according to the first embodiment of the present invention. Using this function, a user may simply update his/her own communication environment information.

\textcircled{1} Communication environment information registration: communication environment information of a CPE communication means connected to the H/W platform is registered in the agency server (MAS) (see FIG. 8).

\textcircled{2} ID means connection: the user connects an ID means (e.g., RFID, employee card, fingerprint and so on) to the sensor.

\textcircled{3} ID information transmission: the sensor recognizes the ID means of the accessed user, and transmits the ID information to the H/W platform.

\textcircled{4} Platform information+ID information transmission: the H/W platform combines the platform information and the user information corresponding to ID and then transmits them to the agency server (MAS).

\textcircled{5} User communication environment information update: the agency server (MAS) updates the communication environment information of the user through the received information.

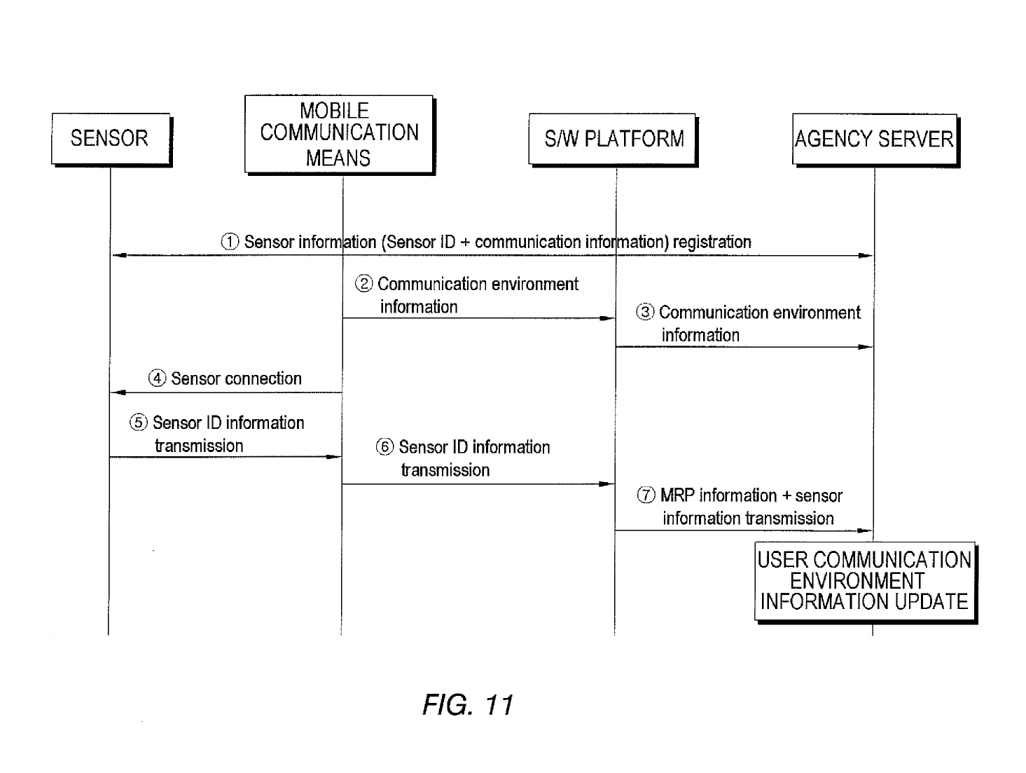

FIG. 11 shows a communication environment information registering process in linkage of the S/W platform and the sensor according to the first embodiment of the present invention. Using this function, a user may simply update his/her own communication environment information.

\textcircled{1} Sensor information registration: sensor ID+communication environment information are registered in the agency server (MAS).

\textcircled{2} Communication environment information: the mobile communication means registers a current communication environment information to the S/W platform.

\textcircled{3} Communication environment information registration: the S/W platform registers the received communication environment information in the agency server (MAS) (see FIG. 9).

\textcircled{4} Sensor connection: the user connects the sensor through the S/W platform as a mobile communication means.

\textcircled{5} Sensor ID information sending: the sensor sends the sensor ID information from the mobile communication means.

\textcircled{6} Sensor ID information transmission: the mobile communication means informs the sensor ID information of the S/W platform.

\textcircled{7} Platform information+sensor ID information transmission: the S/W platform combines the platform information and the sensor ID information and then transmits them to the agency server (MAS).

\textcircled{8} User communication environment information update: the agency server (MAS) updates the communication environment information corresponding to the location of the user through the received information (e.g., the mobile communication means information+the communication means information of the location where the sensor is located are converged).

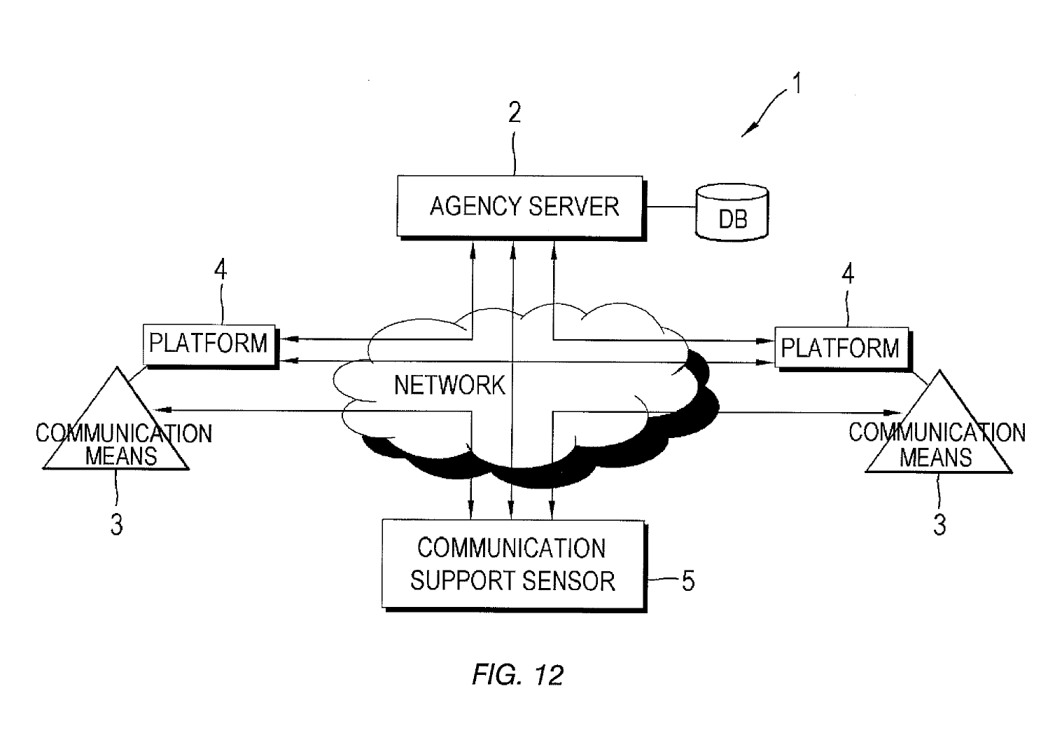

FIG. 12 shows a configuration of a multimedia integrated communication system 1 according to a second embodiment of the present invention. The second embodiment of the present invention further includes a communication support server 5 further to the configuration of the first embodiment of the present invention.

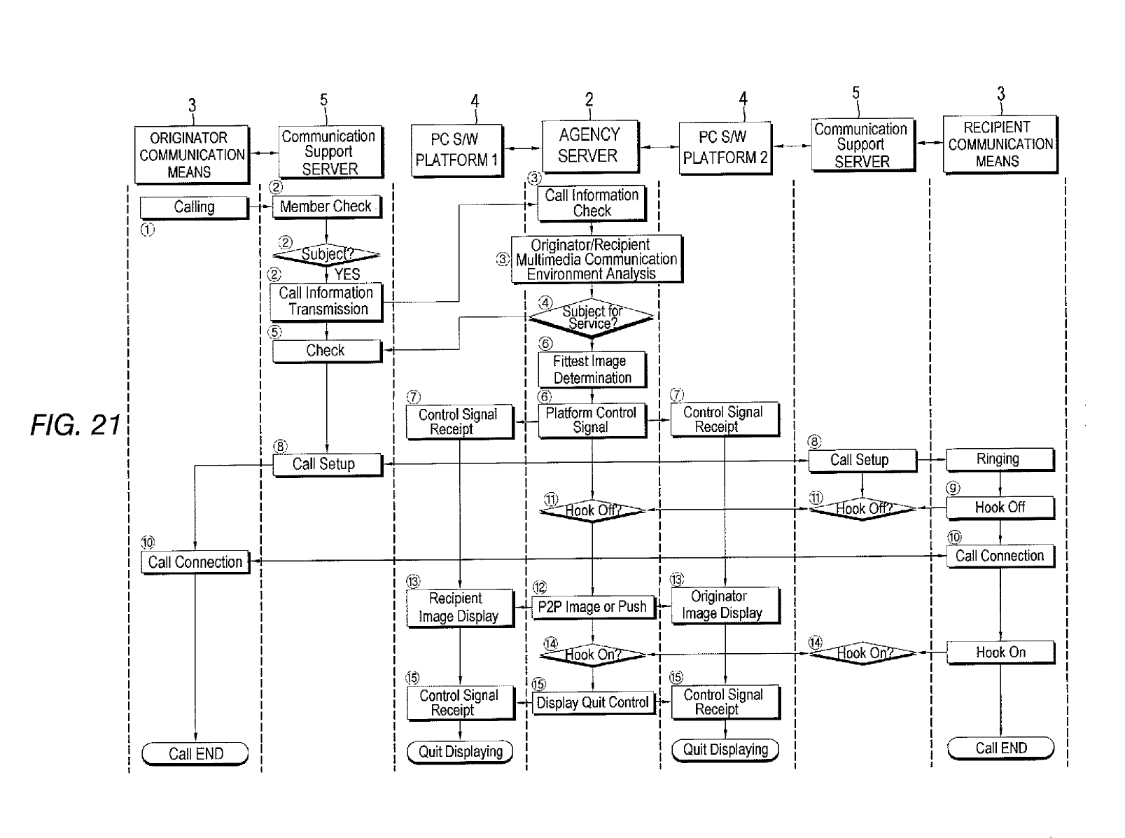

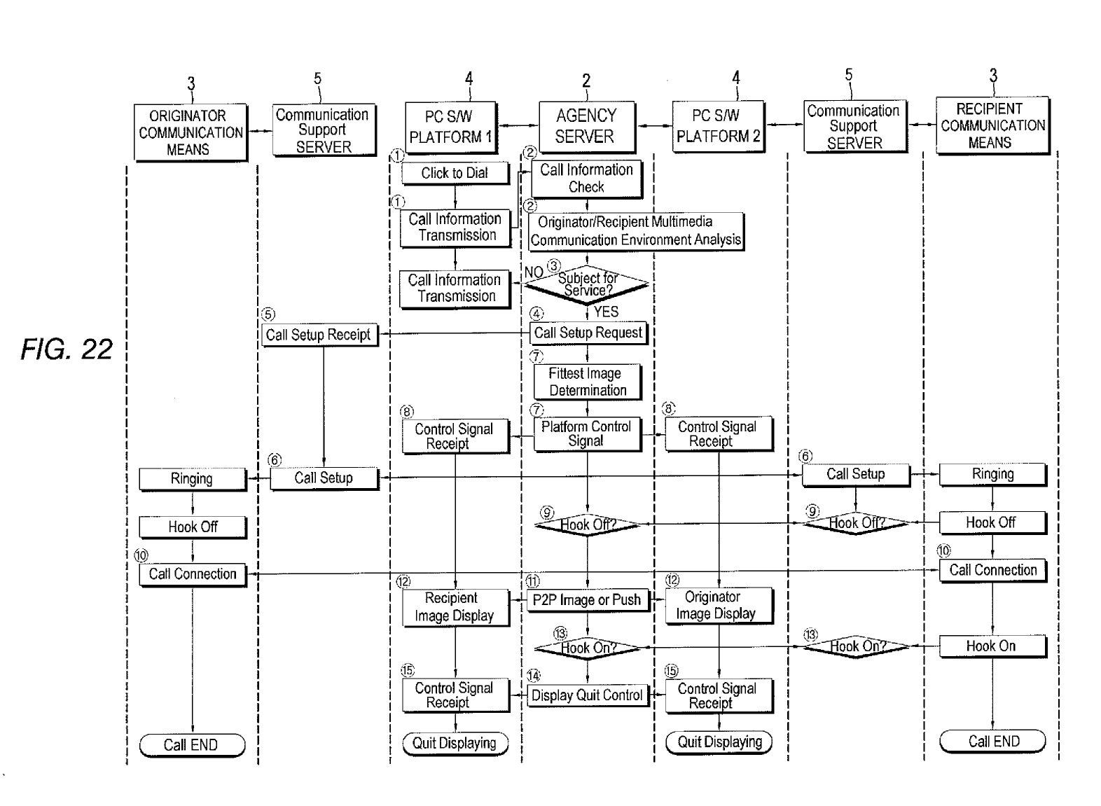

The communication support server 5 plays a role of connecting a call of the voice communication means 31 of a user, and controls call setup in linkage with the agency server 2. In this way, the user may use multimedia communication service in which voice and image are separated by means of linkage of the communication support server 5 and the agency server 2, just using a voice communication means to which a platform is not installed. It will be described below in more detail with reference to FIGS. 21 and 22.

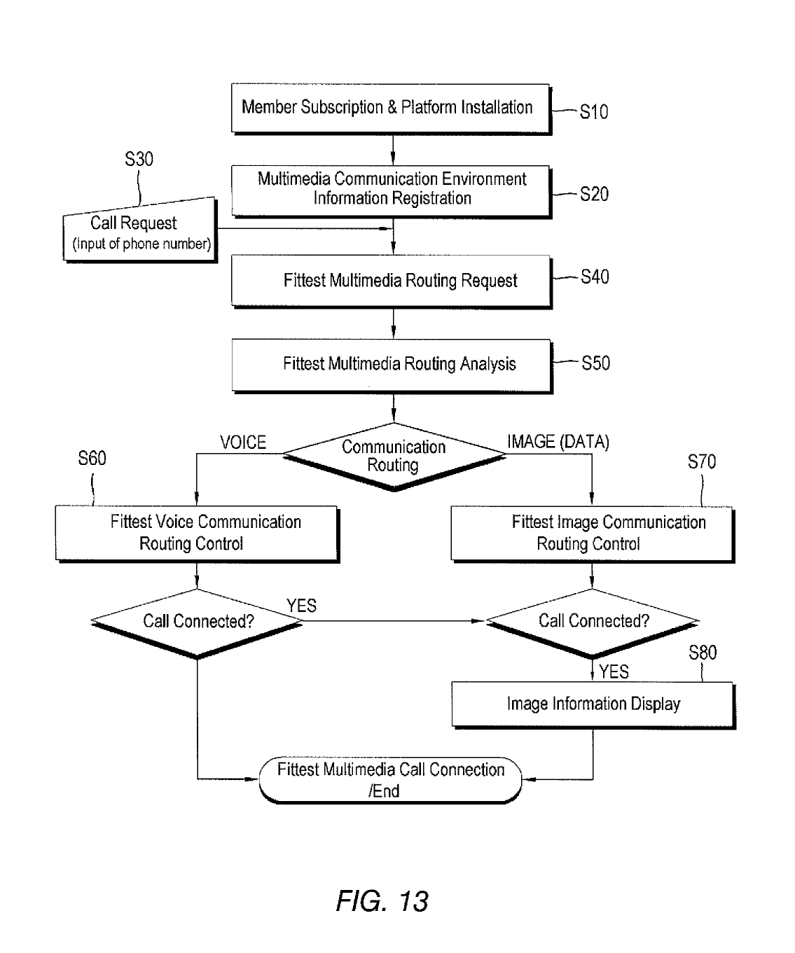

FIG. 13 shows the entire procedure of the multimedia communication method according to the first embodiment of the present invention.

In a member subscription and platform installing step (S10), a user installs a platform (S/W & H/W) 4 to the communication means 3, accesses the agency server 2 to join as a member, and inputs and stores personal information.

In a multimedia communication environment information registering step (S20), current multimedia communication environment information (voice communication means, image communication means, presence information) of the user is manually or automatically registered. In a call request (or, phone number input) step (S30), the user directly inputs a phone number or clicks to dial while the platform is executed.

In a multimedia fittest routing requesting step (S40), the platform 4 transmits a FMR request protocol to the agency server 2 to request a fittest routing.

In a multimedia fittest routing analyzing step (S50), the agency server 2 analyzes priority information (charge/quality/security and so on) according to the correlation and the multimedia communication environment information of the originator and the recipient through the fittest routing information requested by the platform 4, and then calculates a fittest routing (FMR=FCR+FPR).

<Voice Communication Routing Connection>

In a fittest voice communication routing control step (S60), the agency server 2 controls a platform 4 corresponding to the fittest voice communication routing to connect a voice call.

<Image Communication Routing Connection>

In a fittest image communication routing control step (S70), the agency server 2 controls a platform 4 corresponding to the fittest image communication routing to display an image (or, a moving picture).

In an image information displaying step (S80), the agency server 2 controls to display the image information if hook-off information is transmitted from the voice communication means 31 of the recipient.

Through the above steps, the originator and the recipient may easily use cheap and high-quality multimedia communication service in their various multimedia communication environments. In addition, if the voice communication means 31 of the originator or the recipient is hooked on to quit the call, the agency server 2 determines it and then controls the platform 4 to stop displaying of the image communication means.

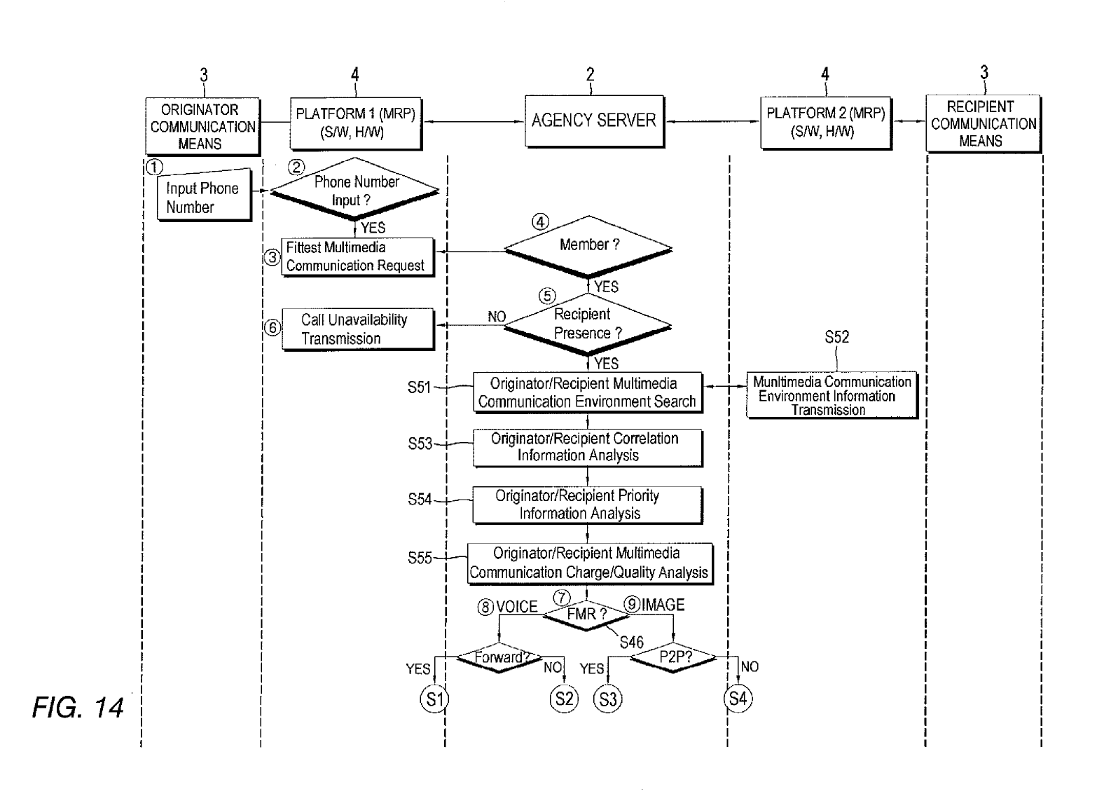

FIG. 14 shows detailed steps of the multimedia fittest routing analyzing step (S50) according to one embodiment of the present invention.

\textcircled{1} Phone number input: an originator inputs a phone number (including Click to Dialing) through his/her own communication means 3 to request a call.

\textcircled{2} Phone number input?: the platform 4 of the originator determines whether a phone number of the originator is input.

\textcircled{3} Fittest multimedia communication request: the platform 4 transmits a FMR request protocol (caller MRP information+caller phone number+recipient phone number+FMR request signal) to the agency server 2 to request a fittest communication routing (FMR).

\textcircled{4} Member?: the agency server 2 determines whether or not a member through the received information.

\textcircled{5} Recipient presence: the agency server 2 searches the presence information of the recipient, and in case of unavailable call, the agency server 2 giving an unavailable call response (\textcircled{6}) to the platform 4 so as to inform the unavailable call to the originator.

In an originator/recipient multimedia communication environment searching step (S51), various multimedia communication environment information of the originator and the recipient are searched through the platform 4, and the communication environment information DB 251 is inquired.

In an originator/recipient correlation information analyzing step (S52), the correlation information DB 212 is inquired through the phone number information of the originator and the recipient.

In an originator/recipient priority information analyzing step (S53), the priority information DB 213 is searched using the correlation information to inquire a calculation criteria of a fittest communication routing.

In an originator/recipient multimedia communication charge/quality analyzing step (S54), the voice communication charge DB 231, the image communication charge DB 232 and the quality information DB 233 are searched to refer to the fittest routing setting information of the user.

\textcircled{7} FMR?: the agency server 2 analyzes FMR in consideration of the multimedia communication environment of the originator and the recipient.

\textcircled{8} Voice: progressing to S1 in case of forward communication and to S2 in case of backward communication, respectively.

\textcircled{9} Image: progressing to S3 in case of P2P and to P4 (mediation image communication) if not, respectively.

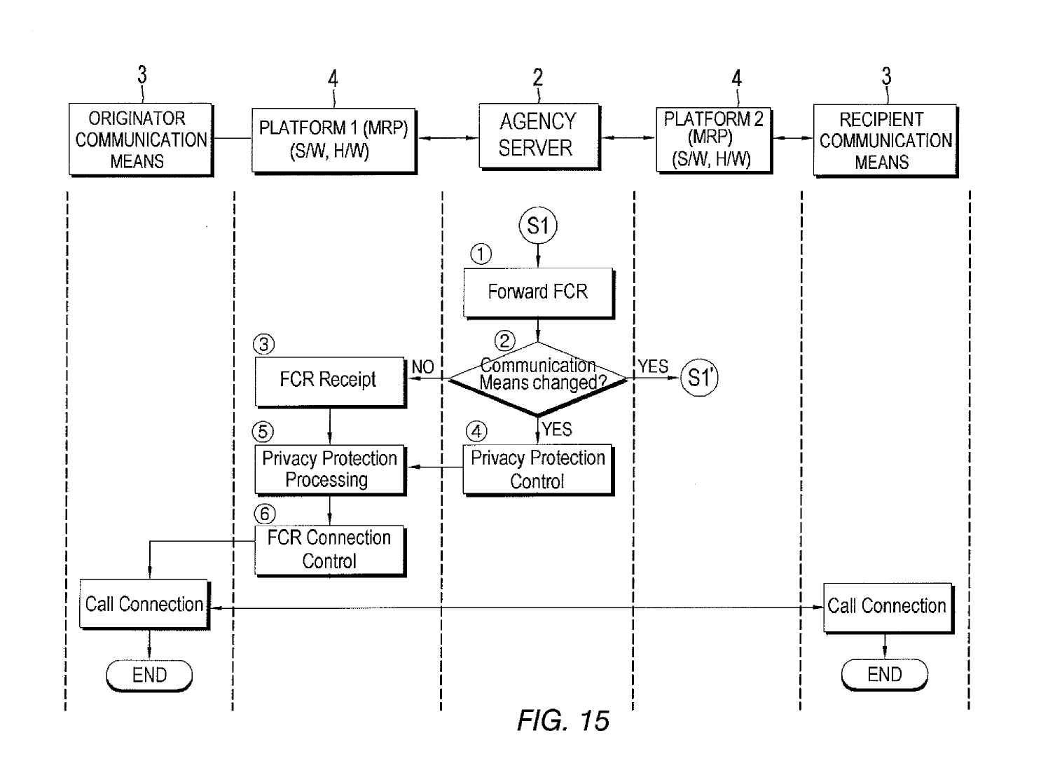

FIG. 15 shows detailed steps of the forward voice communication (with no change of communication means) in the fittest multimedia communication routing.

\textcircled{1} Forward FCR: connecting a voice communication routing from the communication means 3 of the originator to the recipient.

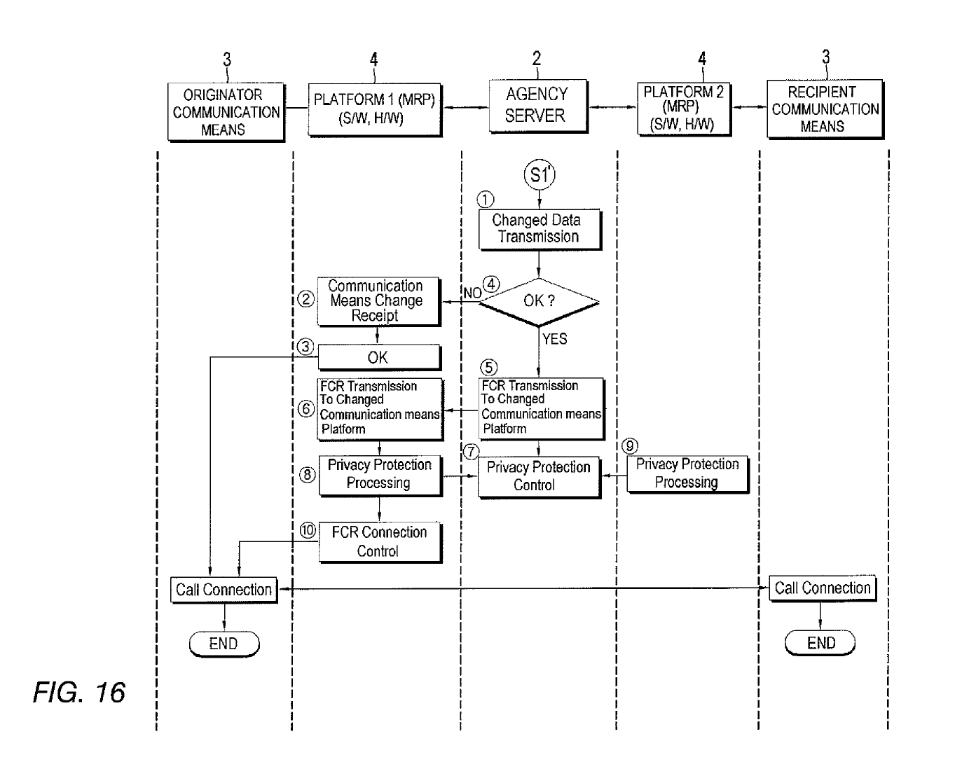

\textcircled{2} Communication means changed?: determining whether a result of the forward FCR (fittest voice communication routing) is a communication means whose phone number is originally input by the originator (e.g., the case that an originator sends a call to a recipient using a mobile phone, but it is best to use a wire phone as a result of FCR determination), and then connecting to S1′ (see FIG. 16) in case of change.

\textcircled{3} FCR receiving: the platform 4 of the originator receives phone number information of the recipient corresponding to the forward FCR if the communication means 3 is not changed.

\textcircled{4} Privacy protection control: in case an originally input phone number is changed into a new number during the FCR connecting process, it is controlled that the phone number of the communication means of the recipient actually connected through the privacy protection protocol (calling MRP=privacy protection signal+signal indicating to change the changed recipient phone number into the original phone number) is changed into the originally input phone number and then displayed on the platform of the originator in order to prevent the personal location information of the recipient is exposed.

\textcircled{5} Privacy protection processing: the platform 4 of the originator receives the privacy protection protocol and changes the phone number.

\textcircled{6} FCR connection control: the platform 4 controls call connection to the phone number of the recipient and sets up the call to connect the call.

FIG. 16 shows detailed steps of the forward voice communication (with a change of communication means) in the fittest multimedia communication routing.

\textcircled{1} Changed data transmission: if the communication means 3 inputting the original phone number of the originator is changed from the forward FCR, the changed data is transmitted to the platform 4 that inputs the original phone number.

\textcircled{2} Communication means change receipt: the original platform 4 of the originator receives data informing change of the communication means and then informs it of the user.

\textcircled{3} OK: if the originator gives an OK sign (clicks a confirmation button), it is transmitted to the agency server 2, but if not, the process is progressed to No communication means change of FIG. 15.

\textcircled{4} OK?: the agency server 2 receives a confirmation signal of the originator.

\textcircled{5} FCR transmission to the changed communication means platform 4: FCR information is transmitted to the platform 4 of the communication means 3 corresponding to FCR of the originator to request a call connection.

\textcircled{6} FCR receipt of the changed communication means platform: a new platform 4 of the originator receives FCR information.

\textcircled{7} Privacy protection control: it is controlled to change the phone number of the originator and the recipient through the originator privacy protection protocol (calling MRP=privacy protection signal+signal indicating to change the changed recipient phone number into the original phone number) and the recipient privacy protocol (called MRP=privacy protection signal+signal indicating to change the changed caller phone number into the original phone number+original phone number).

\textcircled{8} Privacy protection processing: the platform 4 of the originator receives the privacy protection protocol and changes the phone number.

\textcircled{9} Privacy protection processing: the platform 4 of the recipient receives the privacy protection protocol and changes the phone number.

\textcircled{10} FCR connection control: the changed originator platform 4 controls call connection to the communication routing corresponding to FCR and sets up the call to quit the call if the call is ended.

*245FIG. 17 shows detailed steps of the backward voice communication in the fittest multimedia communication routing.

\textcircled{1} Backward FCR: a voice communication routing is connected from the communication means of the recipient to the originator.

\textcircled{2} Communication means changed?: it is determined whether a result of the backward FCR is a communication means whose phone number is originally input by the originator.

\textcircled{3} Backward FCR receipt (originator): the platform 4 of the originator processes call connection corresponding to the backward FCR protocol (caller MRP=backward FCR signal+recipient receiving phone number+backward voice communication connection) if the communication means is not changed.

\textcircled{4} Backward call standby: the originator platform 4 stands by backward call receipt from the recipient, progressed to S2-1.

\textcircled{5} Changed data transmission: if the communication means 4 whose phone number is originally input by the originator is changed from the forward FCR, the changed data is transmitted to the platform 4 that inputs the original phone number.

\textcircled{6} Communication means change receipt: the platform 4 of the originator receives information that the communication means is changed, and then informs it of a user.

\textcircled{7} OK: if the originator gives an OK sign (clicks a confirmation button), it is transmitted to the agency server 2.

\textcircled{8} OK?: the agency server 2 receives a confirmation signal of the originator.

\textcircled{9} Changed backward FCR processing: the agency server transmits the changed originator backward FCR protocol (caller MRP=backward FCR signal+recipient receiving phone number+backward voice call connection standby signal) and the recipient backward protocol (called MRP=backward FCR signal+calling phone number+backward voice call connection control signal) to process backward FCR, and then progressed to S2-3.

\textcircled{10} Changed communication means MRP FCR receipt: the platform 4 of the originator corresponding to the changed backward FCR receives FCR.

*256\textcircled{11} Backward FCR connection control: the changed originator platform 4 makes the communication means ringing to control a call.

\textcircled{12} Ringing: a dummy ring is generated to inform the originator that a call is being connected.

\textcircled{13} Backward call standby: the platform 4 stands by receipt of backward call from the recipient.

\textcircled{14} Backward FCR receipt (recipient): the platform 4 of the recipient receives a backward call control request signal by control of the agency server.

\textcircled{15} Backward call sending: the platform 4 of the recipient sends a backward call, and progressed to S2-2.

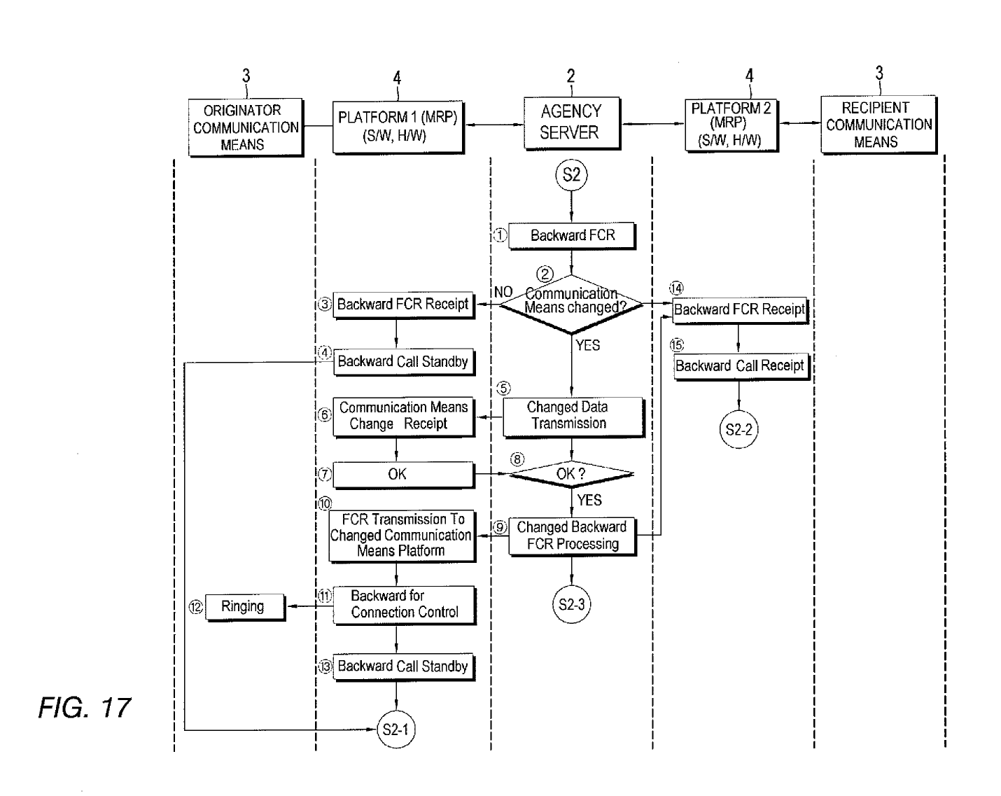

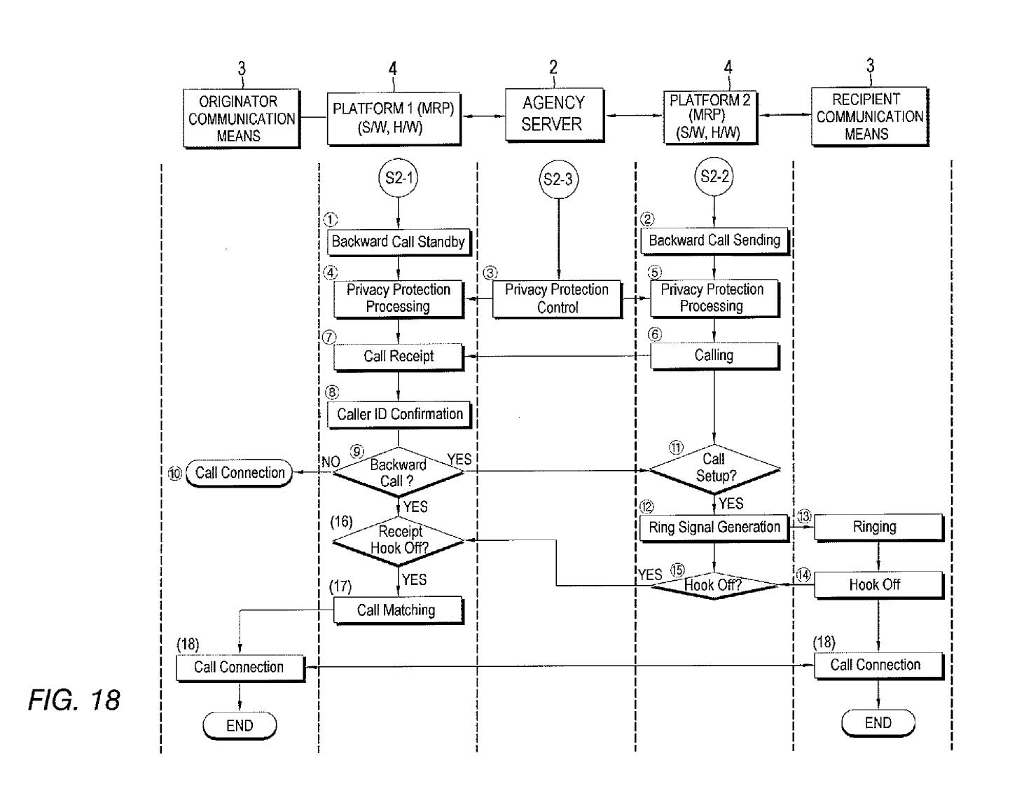

FIG. 18 shows the call setup process of the backward fittest voice communication routing (FCR) of FIG. 17 in detail.

\textcircled{1} Backward call standby: connected from S2-1, the platform 4 of the originator stands by a backward call.

\textcircled{2} Backward call sending: connected from S2-2, the platform 4 of the recipient sends a backward call.

\textcircled{3} Privacy protection control: connected from S2-3, it is controlled to change a phone number of the originator and the recipient through the originator privacy protection protocol (caller MRP=privacy protection signal+signal indicating to change the changed recipient phone number into the original number) and the recipient privacy protocol (called MRP=privacy protection signal+signal indicating to change the changed originator phone number into the original number+original phone number).

\textcircled{4} Privacy protection process: the platform 4 of the originator receives the privacy protection protocol and changes the phone number.

\textcircled{5} Privacy protection processing: the platform 4 of the recipient receives the privacy protection protocol and changes the phone number.

\textcircled{6} Calling: the platform 4 of the recipient controls the communication terminal (S/W platform) and CPE (H/W platform) to send a call to a phone number corresponding to the platform 4 of the originator.

\textcircled{7} Call receipt: the platform 4 of the originator receives the call sent from the recipient.

\textcircled{8} Caller ID confirmation: CID sent from the recipient is confirmed.

\textcircled{9} Backward call?: it is checked whether or not a backward call.

*271\textcircled{10} Call connection: the platform 4 of the originator controls direct call connection if it is not a backward call.

\textcircled{11} Call setup?: if it is a backward call in \textcircled{9}, the platform 4 of the originator sends an OK signal to the platform 4 of the recipient to set up the call.

\textcircled{12} Ring signal generation: the platform 4 of the recipient generates a ring signal.

\textcircled{13} Ringing: a ring is generated in the communication means 3 of the recipient.

\textcircled{14} Hook off: Hook off of the recipient.

\textcircled{15} Hook off: the platform 4 of the recipient senses a hook-off signal of the recipient and sends it to the platform 4 of the originator.

\textcircled{16} Hook off?: the platform 4 of the originator receives the hook-off signal of the recipient and then matches the call.

\textcircled{17} Call matching: the platform 4 of the originator connects the call connected to the communication means of the originator.

\textcircled{18} Call connection: the originator and the recipient connect a call.

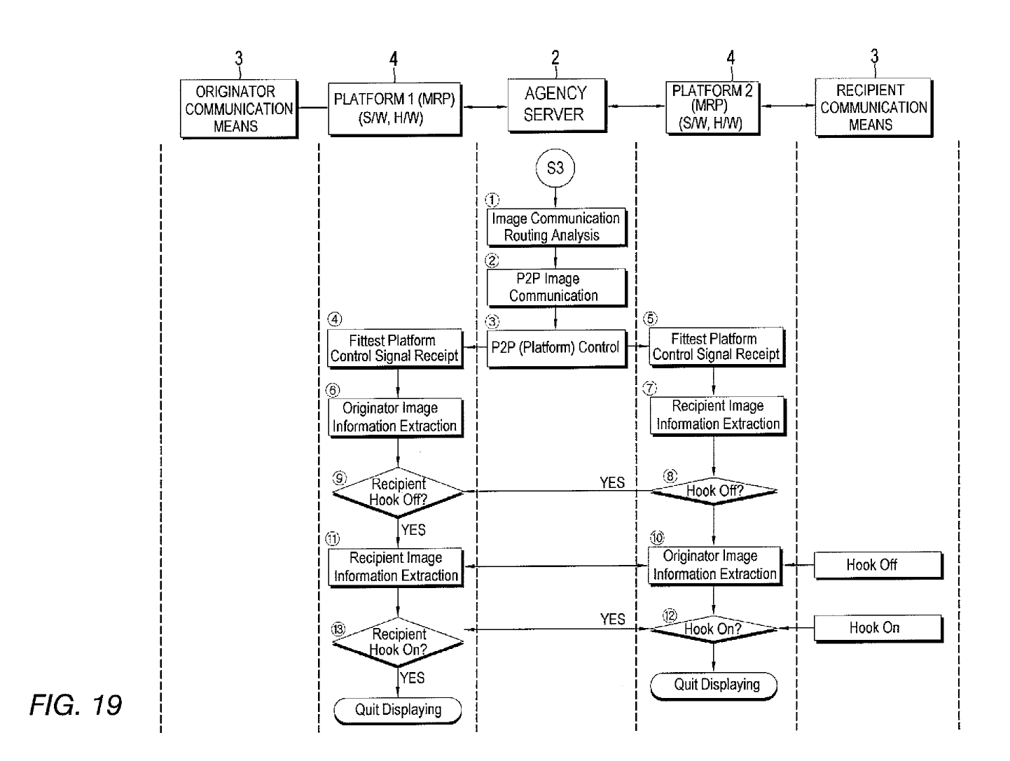

FIG. 19 shows detailed steps of the image communication process (P2P communication) along the fittest image communication routing according to one embodiment of the present invention.

\textcircled{1} Image communication routing analysis: connected from S3 (see FIG. 12), an image communication routing is analyzed.

\textcircled{2} P2P image communication: the platform 4 of the originator and the recipient plays a role of server/client as Peer, and directly communicates without passing through the agency server 2.

\textcircled{3} P2P control: the agency server 2 transmits P2P fittest FPR protocol (calling MRP IP address endowment+called MRP IP address endowment+FPR information+image call standby signal) to connect P2P mutual session so that the platform 4 of the originator and the recipient can conduct P2P image communication.

\textcircled{4} Fittest MRP control signal receipt (originator): the platform 4 corresponding to the optimized image communication means 32, 33 of the originator receives a control signal for P2P image communication.

\textcircled{5} Fittest MRP control signal receipt (recipient): the platform 4 corresponding to the optimized image communication means 32, 33 of the recipient receives a control signal for P2P image communication.

\textcircled{6} Originator image information extraction: the platform 4 corresponding to the image communication means 32, 33 of the originator extracts image information (moving picture, moving image data, static image data and so on) of the originator by controlling the communication means.

\textcircled{7} Recipient image information extraction: the platform 4 corresponding to the image communication means 32, 33 of the recipient extracts image information (moving picture, moving image data, static image data and so on) of the recipient by controlling the communication means.

\textcircled{8} Hook off?: the platform 4 of the optimized voice communication means of the recipient determines a hook-off signal of the recipient and transmits it to the optimized image communication means platform of the originator and the recipient.

\textcircled{9} Recipient Hook off?: the optimized image communication means platform 4 of the originator receives a hook-off signal of the recipient.

\textcircled{10} Originator image information display: the recipient platform 4 displays the image information transmitted from the originator platform 4 by P2P.

\textcircled{11} Recipient image information display: the originator platform 4 displays the image information transmitted from the recipient platform 4 by P2P.

\textcircled{12} Hook on?: the optimized voice communication means platform 4 of the recipient determines a Hook-on signal of the recipient and transmits it to the platforms of the optimized image communication means 32, 33 of the originator and the recipient.

\textcircled{13} Recipient Hook on?: the optimized image communication means platform 4 of the originator and the recipient receives a Hook-on signal of the recipient and then quits displaying of the regenerated image information.

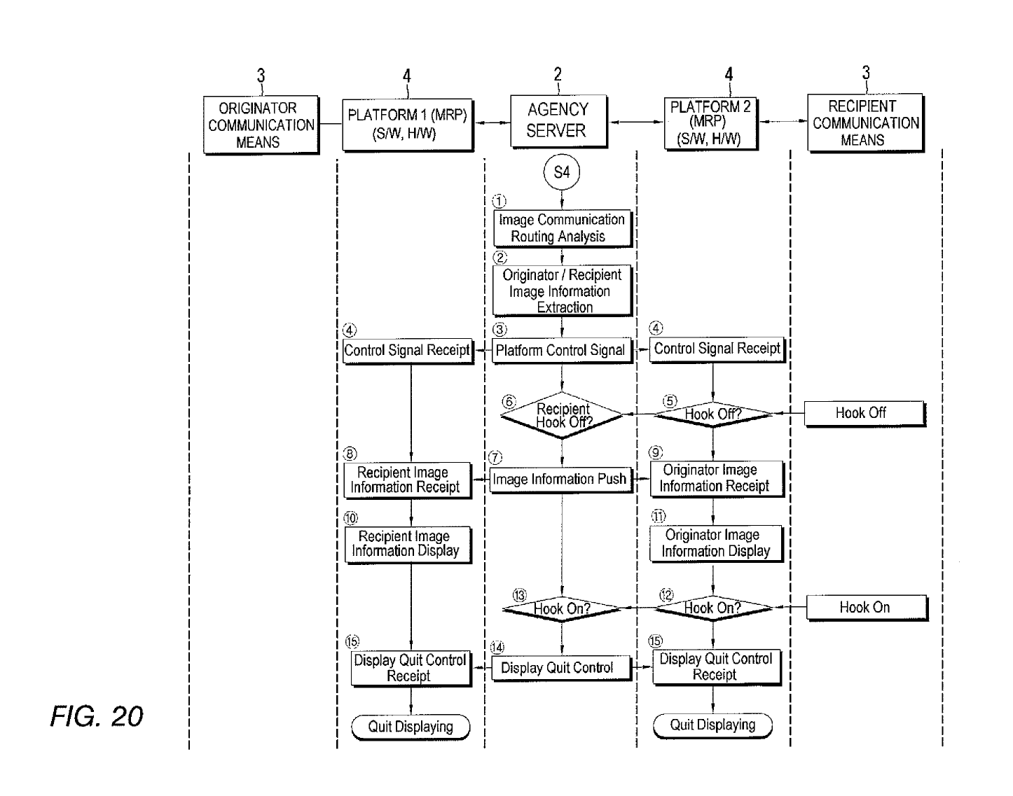

FIG. 20 shows detailed steps of the image communication process (mediation image communication) along the fittest image communication routing according to one embodiment of the present invention.

\textcircled{1} Image communication routing analysis: connected from S4 (see FIG. 12), an image communication routing is analyzed.

\textcircled{2} Originator/recipient image information extraction: correlation between the originator and the recipient is analyzed to extract fittest image information from DB of the agency server 2.

\textcircled{3} Platform control signal: the agency server 2 transmits a control signal for the mediation image communication to the platform 4 of the originator and the recipient so as to progress mediation image communication.

\textcircled{4} Control signal receipt: the fittest image platform 4 of the originator and the recipient receives a control signal.

\textcircled{5} Hook off?: the fittest voice communication means platform 4 of the recipient determines a Hook-off signal of the recipient and transmits it to the agency server 2.

\textcircled{6} Recipient Hook of?: the agency server 2 receives a hook-off signal of the recipient.

\textcircled{7} Image information push: the agency server pushes image information to the platform 4 of the originator and the recipient.

\textcircled{8} Recipient image information receipt: the originator image platform 4 receives the image information of the recipient.

\textcircled{9} Originator image information receipt: the recipient image platform 4 receives the image information of the originator.

\textcircled{10} Recipient image information display: the originator image platform 4 displays the image information of the recipient.

\textcircled{11} Originator image information display: the recipient image platform 4 displays the image information of the originator.

\textcircled{12} Hook on?: the fittest voice communication means platform 4 of the recipient determines a Hook-on signal of the recipient and transmits it to the transmitting agency server 2.

\textcircled{13} Hook on?: the agency server 2 receives a Hook-on signal of the recipient.

\textcircled{14} Display quit control: the agency server 2 transmits a display quit control signal to the platform 4 of the originator and the recipient.

\textcircled{15} Display quit control receipt: the display quit control signal is received to quit displaying of the regenerated image information.

FIG. 21 is a flowchart showing an entire multimedia communication method according to the second embodiment of the present invention, in which the communication support server 5 is added so that an originator sends a voice call using a phone (or, wire/wireless phone) as an example.

\textcircled{1} Calling: an originator inputs a phone number using his/her own communication means 3 to attempt a call.

\textcircled{2} Member check: the communication support server 5 recognizes the communication means 3 of the originator and checks whether the originator is a member of the multimedia communication service.

Subject?: If the originator is not a member, the call is directly set up to connect a general voice call.

Call information transmission: if the originator is a member, the phone number information of the originator (originator phone number+recipient phone number) is transmitted to the agency server 2.

\textcircled{3} Call information check: the agency server 2 checks the information received from the communication support server 5.

Originator/recipient multimedia communication environment analysis: various multimedia communication environment information of the originator and the recipient is grasped.

\textcircled{4} Subject for service: it is determined whether the multimedia communication service is available as a result of grasping the communication environment.

\textcircled{5} Check: availability information is transmitted to the communication support server 5.

\textcircled{6} Fittest image determination: the priority information according to correlation of the originator and the recipient is searched to determine a fittest image (P2P or Push).

MRP control signal: a control signal for image communication is transmitted to the fittest image platform 4 of the originator and the recipient.

\textcircled{7} Control signal receipt: the fittest image platform 4 of the originator and the recipient receives the control signal.

\textcircled{8} Call setup: the communication support server 5 progresses call setup between the originator and the recipient.

\textcircled{9} Hook off: the recipient communication means 3 is hooked off for receiving.

\textcircled{10} Call connection: the voice communication means 31 of the originator and the recipient starts a call through a communication path established.

\textcircled{11} Hook off: the communication support server 5 transmits the recipient hook-off information to the agency server 2.

\textcircled{12} P2P image or Push: the agency server receives the hook-off information of the recipient and controls the image platform of the originator and the recipient to display image information.

\textcircled{13} Recipient image display: the image platform 4 of the originator displays the image information of the recipient.

Originator image display: the image platform 4 of the recipient displays the image information of the originator.

\textcircled{14} Hook on?: the call is ended if the recipient hooks on after the voice communication ends. Hook on?: the communication support server 5 transmits the hook-on information of the recipient to the agency server 2.

\textcircled{15} Display end control: the agency server 2 receives the hook-on information and controls the image platform 4 of the originator and the recipient to transmit a display end. Control signal receipt: the image platform 4 of the originator and the recipient receives a control signal and ends displaying of the image information.

FIG. 22 is a flowchart illustrating the entire multimedia communication method according to the second embodiment of the present invention, in which the communication support server 5 is added so that an originator sends a voice call using the S/W platform (PC), as an example.

\textcircled{1} Click to Dial: Click to Dialing while a first S/W platform 4 is executed.

Call information transmission: the first S/W platform 4 transmits originator call information (originator (ID) phone number+recipient phone number) to the agency server 2.

\textcircled{2} Call information check: the agency server 2 receives and checks call information. Originator/recipient multimedia communication environment analysis: various multimedia communication environments of the originator and the recipient are grasped.

\textcircled{3} Subject for service: it is determined whether multimedia communication service is available as a result of grasping communication environments, and then it is transmitted to the first S/W platform 4 if unavailable.

\textcircled{4} Call setup request: if the service is available, the agency server requests call setup to the communication support server 5.

\textcircled{5} Call setup receipt: the communication support server 5 receives the call setup signal of the agency server 2 and then sets up the call of the originator and the recipient.

\textcircled{6} Call setup: the communication support server 5 receives the call setup request of the communication support server 5 and sets up the call.

\textcircled{7} Fittest image determination: the priority information according to correlation between the originator and the recipient is searched to determined a fittest image (P2P or Push).

MRP control signal: a control signal for image communication is transmitted to the fittest image platform 4 of the originator and the recipient.

\textcircled{8} Control signal receipt: the fittest image platform 4 of the originator and the recipient receives the control signal.

\textcircled{9} Hook off: the communication means 3 of the recipient hooks off to receive the call. Hook off: the communication support server 5 transmits the hook-off information of the recipient to the agency server 2.

\textcircled{10} Call connection: the voice communication means 31 of the originator and the recipient starts a call through a communication path established.

\textcircled{11} P2P image or Push: the agency server 2 receives the hook-off information of the recipient and controls the image platform 4 of the originator and the recipient to display the image information (P2P image communication and the image communication using Push of the agency server, see the former description).

\textcircled{12} Recipient image display: the image platform 4 of the originator displays the image information of the recipient.

Originator image display: the image platform 4 of the recipient displays the image information of the originator.

\textcircled{13} Hook on?: the call is ended if the recipient quits (hooks on) the voice call.

Hook on?: the communication support server 5 transmits the hook-on information of the recipient to the agency server 2.

\textcircled{14} Display end control: the agency server 2 receives the hook-on information and controls the image platform 4 of the originator and the recipient to transmit a display end.

\textcircled{15} Control signal receipt: the image platform 4 of the originator and the recipient receives the control signal to end displaying of the image information.

As described above, the multimedia integrated communication system for routing a fittest communication path depending on multimedia communication environments of a user, and a 30 communication method using the same according to one embodiment of the present invention have been described. However, it should be understood that the detailed description and specific examples, while embodiments of the invention, are given by way of illustration only, since various changes and modifications within the spirit and scope of the invention will become apparent to those skilled in the art from this detailed description.

At least one embodiment of the present invention uses various communication means of different kinds possessed by a user, without needing the user to have any dedicated communication means for multimedia communication using voice and image, thereby economically providing multimedia communication service with a small initial investment.

At least one embodiment of the present invention, served to the user, changes into a communication manner having fittest charge, quality and security in consideration of communication environments of the user and an opponent call by call, thereby providing cheaper and more efficient multimedia communication service.

In addition, in contrast to the existing image communication which may cause problems in protection of private life when making unconditional image communication with many unspecified persons, one embodiment of the present invention contributes to protection of private life by automatically extracting an optimal image information by means of condition values (correlations such as family, friend, and colleague at work) already registered by a user. For example, as for an opponent not included in the relations already set by a user, an image data previously registered may be automatically displayed.

What is claimed is:

1. A method of providing an optimal telecommunication route, the method comprising:
communicating data with an originating terminal and a receiving terminal, wherein at least one of the originating terminal and receiving terminal is configured to support multimedia data communication;
storing i) priority information provided by a user of the originating terminal and ii) information associated with telecommunication routes between the originating terminal and receiving terminal, wherein the priority information comprises a plurality of telecommunication connection criteria and their relative rankings defined by the user, and wherein the communication route information comprises a list of a plurality of telecommunication networks which indicates the relative rankings of the plurality of telecommunication networks for each of the plurality of telecommunication connection criteria;
receiving a request for telecommunication route information from the originating terminal;
obtaining an optimal telecommunication route, based on the stored information i) and ii), between the originating terminal and receiving terminal; and
transmitting the obtained optimal route to the originating terminal.

2. The method of claim 1, wherein the optimal telecommunication route is the telecommunication network which has the highest ranking on the telecommunication connection criterion selected by the user to be the highest priority.

3. The method of claim 1, wherein the telecommunication connection criteria comprise communication quality, service fees and communication security.

4. The method of claim 1, further comprising detecting the type of the originating terminal, wherein the optimal telecommunication route is obtained based on the stored information and the detected terminal type.

5. The method of claim 1, further comprising storing iii) relationship information between the user and a plurality of recipients, wherein the optimal telecommunication route is obtained based on the stored information (i)-iii)).

6. The method of claim 5, wherein the relationship information defines the degree of the relationship, and wherein the rank of a recipient becomes higher as the user becomes closer in relationship to the recipient.

7. The method of claim 5, further comprising downloading a software platform to the originating terminal, wherein the optimal route information is configured to control the software platform of the originating terminal to communicate data with the recipient terminal.

8. The method of claim 1, wherein the optimal route information comprises a first route for voice communication and a second route for video communication, and wherein the first and second routes are different from each other.

9. The method of claim 8, wherein the optimal route information is configured to control the originating terminal to separately communicate a voice signal via the first route and video data via the second route with the recipient terminal.

10. The method of claim 9, wherein the recipient terminal comprises i) a computing device configured to process the video data and ii) an information terminal configured to process the voice signal.

11. The method of claim 10, wherein the information terminal comprises a wired or wireless phone.

12. The method of claim 1, wherein the obtained route information comprises one of i) a forward communication route configured to connect a call for a voice signal from the originating terminal to the recipient terminal and ii) a backward communication route configured to connect a call for a voice signal from the recipient terminal to the originating terminal.

13. The method of claim 1, further comprising providing a peer-to-peer communication for multimedia data between the originating terminal and recipient terminal if both of the terminals support multimedia data communication.

14. The method of claim 1, further comprising transmitting multimedia data to the recipient terminal via a push protocol.

15. The method of claim 14, further comprising receiving a recipient's presence information, indicating the availability of the recipient, from the recipient terminal, wherein the timing for transmitting the multimedia data is controlled based on the presence information.

16. The method of claim 1, further comprising controlling the originating terminal so as to delay the connection between the originating and recipient terminals until the optimal telecommunication route information is transmitted to the originating terminal.

17. A system for providing an optimal telecommunication route, the system comprising:
a memory configured to store i) priority information provided by a user of an originating terminal and ii) information associated with telecommunication routes between the originating terminal and a receiving terminal, wherein the priority information comprises a plurality of telecommunication connection criteria and their relative rankings defined by the user, and wherein the communication route information comprises a list of a plurality of telecommunication networks which indicates the relative rankings of the plurality of telecommunication networks for each of the plurality of telecommunication connection criteria; and
a processor configured to:
i) communicate data with the originating terminal and receiving terminal, wherein at least one of the originating terminal and receiving terminal is configured to support multimedia data communication;
ii) receive a request for telecommunication route information from the originating terminal;
iii) obtain an optimal telecommunication route, based on the information stored in the memory, between the originating terminal and receiving terminal; and
iv) transmit the obtained route information to the originating terminal.

18. The system of claim 17, wherein the optimal telecommunication route is the telecommunication network which has the highest ranking on the telecommunication connection criterion selected by the user to be the highest priority.

19. The system of claim 17, wherein the telecommunication connection criteria comprise communication quality, service fees and communication security.

20. The system of claim 17, wherein the optimal route information comprises a first route for voice communication and a second route for video communication, and wherein the first and second routes are different from each other.

21. The system of claim 17, wherein the memory is further configured to store iii) relationship information between the user and a plurality of recipients, and wherein the processor is further configured to obtain the optimal telecommunication route based on the stored information (i)-iii)).

22. The system of claim 17, wherein the plurality of telecommunication networks comprise at least two of the following: a PSTN, a wired Internet, a wireless Internet and a wireless LAN.

23. One or more processor-readable storage devices having processor-readable code, the processor-readable code for programming one or more processors to perform a method of providing an optimal telecommunication route, the method comprising:
communicating data with an originating terminal and a receiving terminal, wherein at least one of the originating terminal and receiving terminal is configured to support multimedia data communication;
storing i) priority information provided by a user of the originating terminal and ii) information associated with telecommunication routes between the originating terminal and receiving terminal, wherein the priority information comprises a plurality of telecommunication connection criteria and their relative rankings defined by the user, and wherein the communication route information comprises a list of a plurality of telecommunication networks which indicates the relative rankings of the plurality of telecommunication networks for each of the plurality of telecommunication connection criteria;
receiving a request for telecommunication route information from the originating terminal;
obtaining an optimal telecommunication route, based on the stored information i) and ii), between the originating terminal and receiving terminal; and
transmitting the obtained optimal route to the originating terminal.

24. A system for providing an optimal telecommunication route, the system comprising:
means for communicating data with an originating terminal and a receiving terminal, wherein at least one of the originating terminal and receiving terminal is configured to support multimedia data communication;
means for storing i) priority information provided by a user of the originating terminal and ii) information associated with telecommunication routes between the originating terminal and receiving terminal, wherein the priority information comprises a plurality of telecommunication connection criteria and their relative rankings defined by the user, and wherein the communication route information comprises a list of a plurality of telecommunication networks which indicates the relative rankings of the plurality of telecommunication networks for each of the plurality of telecommunication connection criteria;
means for receiving a request for telecommunication route information from the originating terminal;
means for obtaining an optimal telecommunication route, based on the stored information i) and ii), between the originating terminal and receiving terminal; and
means for transmitting the obtained optimal route to the originating terminal.

25. A method of providing an optimal telecommunication route, the method comprising:
providing to a server, at an originating terminal, priority information provided by a user of the originating terminal, wherein the priority information comprises a plurality of telecommunication connection criteria and their relative rankings defined by the user, and wherein the server is in signal or data communication with the originating terminal;
transmitting a request for an optimal telecommunication route, between the originating terminal and a recipient terminal, to the server, wherein at least one of the originating terminal and receiving terminal is configured to support multimedia data communication;
receiving an optimal telecommunication route from the server; and
communicating signal or data with the recipient terminal via the optimal telecommunication route.
